(19) United States
(12) Patent Application Publication
(10) Pub. No.: US 2021/0350479 A1
(43) Pub. Date: Nov. 11, 2021

(54) Systems and Methods for Communicating with Secondary Users of a Transportation Service

(71) Applicant: Joby Elevate, Inc., Santa Cruz, CA (US)

(72) Inventors: Raphael Max Lurie, San Francisco, CA (US); Nishit Tewari, San Francisco, CA (US); Varun Rau, San Francisco, CA (US); Adam Warmoth, San Francisco, CA (US); Kevin Tian, San Francisco, CA (US)

(21) Appl. No.: 17/308,680

(22) Filed: May 5, 2021

Related U.S. Application Data
(60) Provisional application No. 63/020,279, filed on May 5, 2020.

(51) Int. Cl. G06Q 50/14; G06Q 10/02

(52) U.S. Cl. CPC G06Q 50/14; G06Q 10/025

(57) ABSTRACT

Systems and methods for communicating with secondary users of a transportation service are provided. A method can include obtaining a request for a transportation service including an aerial transport of a first user from a first user device associated with the first user. The method can include generating a first multi-modal transportation itinerary for facilitating the aerial transport for the first user. The method can include obtaining data indicative of a second user that is to travel with the first user for at least a portion of the first multi-modal transportation itinerary and determining a second multi-modal transportation itinerary for facilitating the aerial transport for the second user. The method can include communicating passenger itinerary data indicative of the second multi-modal transportation itinerary to a second user device associated with the second user.

### RELATED APPLICATIONS

This application claims priority to and the benefit of U.S. Provisional Patent Application No. 63/020,279, filed May 5, 2020, which is hereby incorporated by reference in its entirety.

### FIELD

The present disclosure relates generally to interacting with secondary users of a multi-modal transportation service in a multi-modal ride sharing network.

### BACKGROUND

Transportation services applications exist which enable individual users to request transportation on demand. For example, transportation services currently exist which enable drivers of ground-based vehicle (e.g., “cars”) to provide transportation services for potential passengers, as well as to deliver packages, goods, and/or prepared foods. However, certain current services are limited to a single transportation modality, namely transportation via cars, bikes, or scooters. As urban areas become increasingly dense, ground infrastructure such as roadways will become increasingly constrained and congested and, as a result, ground-based transportation may not suitably serve the transportation needs of a significant number of users.

### SUMMARY

Aspects and advantages of embodiments of the present disclosure will be set forth in part in the following description, or may be learned from the description, or may be learned through practice of the embodiments.

One example aspect of the present disclosure is directed to a computing system including one or one or more processors and one or more tangible, non-transitory, computer readable media that collectively store instructions that when executed by the one or more processors cause the computing system to perform operations. The operations include obtaining a request for a transportation service that comprises at least an aerial transport of a first user. The request is generated via a first user device associated with the first user. The operations include generating a first multi-modal transportation itinerary for facilitating the aerial transport for the first user. The itinerary includes at least a first transportation leg, a second transportation leg, and a third transportation leg. The operations include obtaining data indicative of a second user that is to travel with the first user for at least a portion of the first multi-modal transportation itinerary. The operations include determining a second multi-modal transportation itinerary for facilitating the aerial transport for the second user. The second multi-modal transportation itinerary at least initially matches the first multi-modal transportation itinerary. The operations include communicating passenger itinerary data indicative of the second multi-modal transportation itinerary to a second user device associated with the second user.

Another example aspect of the present disclosure is directed to a computer-implemented method. The method includes obtaining, by a computing system comprising one or more computing devices, a request for a transportation service that comprises at least an aerial transport of a first user. The request is generated via a first user device associated with the first user. The method includes generating, by the computing system, a multi-modal transportation itinerary for facilitating the aerial transport for the first user. The itinerary includes at least a first transportation leg, a second transportation leg, and a third transportation leg. The method includes obtaining, by the computing system from the first user device, data indicative of a second user associated with the first user. The data indicative of the second user includes a privilege level associated with the second user. The method includes associating, by the computing system, the second user with the multi-modal transportation itinerary. The method includes communicating, by the computing system, passenger itinerary data indicative of the multi-modal transportation itinerary to a second user device associated with the second user based, at least in part, on the privilege level associated with the second user.

Yet another example aspect of the present disclosure is directed to another computing system including one or one or more processors and one or more tangible, non-transitory, computer readable media that collectively store instructions that when executed by the one or more processors cause the computing system to perform operations. The operations include obtaining a request for a transportation service that comprises at least an aerial transport of a first user. The request is generated via a first user device associated with the first user. The operations include generating a multi-modal transportation itinerary for facilitating the aerial transport for the first user. The itinerary includes at least a first transportation leg, a second transportation leg, and a third transportation leg. The operations include obtaining, from the first user device, data indicative of a second user associated with the first user. The operations include associating the second user with the multi-modal transportation itinerary. The operations include communicating passenger itinerary data indicative of the first transportation leg, the second transportation leg, and the third transportation leg to a second user device associated with the second user.

Other example aspects of the present disclosure are directed to other systems, methods, vehicles, apparatuses, tangible non-transitory computer-readable media, and devices for generating and communicating aerial vehicle sensory cues.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system according to example implementations of the present disclosure;

FIG. 2 depicts an example multi-modal transportation itinerary according to example implementations of the present disclosure;

FIG. 3 depicts an example data flow diagram according to example implementations of the present disclosure;

FIG. 4 depicts an example multi-modal transportation itinerary data structure according to example implementations of the present disclosure;

FIG. 5 depicts an example multi-modal transportation itinerary with multiple first transportation legs according to example implementations of the present disclosure;

FIG. 6 depicts a first multi-modal transportation itinerary and a second multi-modal transportation itinerary according to example implementations of the present disclosure;

FIG. 7 depicts a flowchart diagram of an example method of planning and fulfilling a multi-modal transportation service according to example implementations of the present disclosure;

FIG. 8 depicts a flowchart diagram of an example method of updating a multi-modal transportation itinerary according to example implementations of the present disclosure;

FIG. 9 depicts a flowchart diagram of an example method of providing passenger itinerary data according to example implementations of the present disclosure;

FIG. 10 depicts example system components according to example embodiments of the present disclosure.

### DETAILED DESCRIPTION

Aspects of the present disclosure are directed to improved systems and methods for interacting with secondary users of a multi-modal transportation service in a multi-modal ride sharing network. In particular, aspects of the present disclosure are directed to a computing system configured to create a multi-modal transportation itinerary responsive to a user request for a transportation service. For instance, a service entity can manage and coordinate a plurality of different types of vehicles to provide services to a plurality of users via a transportation platform. By way of example, a first user may generate a service request for transportation from an origin location to a destination location via an application running on the first user's device (e.g., mobile phone, etc.). An operations computing system associated with the service entity (e.g., a cloud-based operations computing, etc.) can obtain data indicative of the service request and generate a user itinerary to facilitate transporting the first user from the origin location to the destination location. The itinerary can be a multi-modal transportation itinerary that includes at least two types of transportation such as, for example, ground-based vehicle transportation and aerial transportation. For example, the itinerary can include three legs: a first leg that includes a ground-based vehicle transporting the first user from the origin location (e.g., a home, etc.) to a first aerial transport facility; a second leg (e.g., an aerial portion) that includes an aerial vehicle transporting the first user from the first aerial transport facility to a second aerial transport facility; and a third leg that includes another ground-based vehicle transporting the first user from the second aerial transport facility to the destination location (e.g., a conference center). The first user may desire to include other user(s) in the transportation service. To do so, the requesting user may communicate (e.g., via the user device) plus-one data to the operations computing system indicating that a second user will be travelling with the first user.

The technology of the present disclosure provides an improved approach to facilitating transportation for the second, plus-one user, while also providing for customizable control over the second user's travel itinerary. For example, the first user can communicate information associated with a second user to the operations computing system (e.g., plus-one data). This can include, for example, an email address, a phone number, a name, an identifier associated with the second user's account with the service entity, etc. The first user can communicate such information with a service request (e.g., before the second user is travelling with the first user) or some time thereafter (e.g., while the second user is travelling with the first user). The operations computing system can utilize the information to interact with the second user concerning the multi-modal transportation itinerary. The operations computing system can determine an itinerary for the second user based on the first user's itinerary. The second user's itinerary can, at least initially, match the first user's itinerary, as further described herein.

The operations computing system can provide the second user information regarding the itinerary and allow the second user to adjust the second user's itinerary, if permitted. For instance, the operations computing system can monitor the progress of the second user along the itinerary and communicate information (e.g., trip details, boarding passes, etc.) concerning the transportation service to the second user based on the progress. In addition, the operations computing system can receive an update request from a second user device associated with the second user and update (e.g., add supplemental information, accept/cancel rides, change destination location, etc.) the second user's itinerary based on the update request. For example, the second user may request a change in destination and the operations computing system may adjust the second user's itinerary accordingly. This update request may not affect the itinerary of the first user. For example, the operations computing system may book the second user a different ground-based vehicle for the third leg of the itinerary than the first user so that each can be separately transported to their respective destinations. In some implementations, the second user can be associated with a privilege level indicative of a level of control over the itinerary. In such a case, the computing system can communicate information and/or update the itinerary based on the privilege level associated with the user. By way of example, if the second user is a minor (travelling with a parent first user) associated with a second privilege level, the operations computing system may reject any update requests to the itinerary and only provide trip detail information to the second user. In another example, if the second user is another adult (travelling with a colleague first user) associated with a fourth privilege level, the operations computing system may permit the second user to make any desired changes to the second user's itinerary.

In this manner, the systems and methods of the present disclosure can enable a computing system to interact with a secondary user of the transportation service to obtain, provide, and/or update information for the itinerary. This, in turn, enables a secondary user that did not request the transportation service to nevertheless exert some control (e.g., viewing control, supplemental control, modification control, etc.) over the service. This can provide a more efficient approach to generating and adjusting itineraries of co-travelers, thereby saving the processing and memory resources of the corresponding computing systems.

More particularly, a service entity can be associated with an operations computing system (e.g., a cloud-based operations computing system, etc.) that is configured to manage, coordinate, and dynamically adjust a multi-modal transportation service via a transportation platform. The multi-modal transportation service can include a plurality of transportation legs, one of which (e.g., a second transportation leg) can include an aerial transport of a user. For example, the operations computing system can obtain a request for a transportation service. The request for the transportation service can include at least a request for an aerial transport of a first user of a transportation platform. The operations computing system can obtain the request from a first user device associated with the first user of the transportation platform. The first user device, for example, can include any type of computing device such as a smartphone, tablet, hand-held computing device, wearable computing device, embedded computing device, navigational computing device, etc. The first user device can include one or more communication interfaces configured to communicate (e.g., via one or more networks such as local area networks, wide area networks, the Internet, secure networks, cellular networks, mesh networks, etc.) with the transportation platform.

In some implementations, the first user device can generate the request. For instance, the first user device can include a first software application running on the first user device. The first software application, for example, can be associated with the first user and/or the transportation platform. For example, the first user can be associated with an account on the transportation platform and the first software application can allow the first user to book a multi-model transportation service of the service entity using the first user's account (e.g., to facilitate payment, maintain usage history, apply discounts, identify preferences, etc.). The first user can interact with the first software application running on the first user device (e.g., via a user interface) to generate the request for the transportation service.

A transportation platform, for example, can include an operations computing system communicatively connected over a network to a plurality of users (e.g., via one or more user devices such as the first user device, etc.), a plurality service providers (e.g., via one or more service provider devices), one or more vehicle operators (e.g., providing vehicles for use on the platform), etc. The transportation platform can be configured to leverage transportation capabilities of the plurality of service providers to schedule and facilitate a multi-modal transportation service for the plurality of users (and/or one or more secondary users associated with the plurality of users). The service entity's computing system can be configured to coordinate multi-modal transportation for the transportation platform.

For example, the operations computing system can obtain a request from a first user that requests the operations computing system to facilitate a transportation service for the first user and/or a second user from one or more origin locations to one or more destination locations. In some instances, the first and second users can utilize the same origin and destination locations, while in other instances the first and second users may have different origin and/or destination locations from one another. By way of example, the first user can interact with the first software application running on the first user device to initiate the request. In some instances, unless specified otherwise, the origin of the transportation service can be assumed to be a current location of the first user (e.g., as indicated by location data such as GPS data received from the user device and/or as input by the first user). The first user can also supply a desired destination (e.g., by typing the destination into a text field which may, for example, provide suggested completed entries while the first user types).

In some implementations, the request can also specify an “arrive by” date and time at which the first user desires to arrive at the requested destination. Thus, the first user can specify when the first user would like to arrive at the destination. In other implementations, the request can indicate a “depart at” date and time that the first user would like to depart. In some examples, the “depart at” date and time can be assumed to be the current date and time unless specified otherwise. The first user can also provide entries for any number of additional characteristics that the first user would like the transportation service to meet. For example, additional entries can specify a required number of seats, a preferred vehicle type (e.g., luxury vs. economy, humanly-operated vs. autonomous, etc.), an estimated payload weight (e.g., passengers and/or luggage weight, etc.), a preferred payload capacity (e.g., so that the vehicle accommodates the weight of any luggage carried by the first user, etc.), maximum price, and/or various other characteristics.

In some implementations, the first user can provide passenger details for the transportation service. For instance, plus-one data can be obtained in addition to the request for the multi-modal transportation service (e.g., from the first user device). The plus-one data can be associated with a second user of the transportation service. For example, the second user can include a user that is to travel with the first user for at least a portion of the transportation service. In addition, or alternatively, the second user can include a user for which the first user is booking the transportation service. Thus, the second user can include a user that is to use the transportation service with or without the first user. The second user can include another user of the transportation platform and/or a user not associated with the transportation platform. For example, the second user can have a user account with the transportation platform. In addition, or alternatively, the second user can include a passenger of the transportation service that is not associated with an account for the transportation platform (e.g., is not a user of the transportation platform).

As an example, in some implementations, the first user can request one or more seats for the transportation service. The request can include at least one seat that is intended for at least one secondary user that is not the first user (e.g., a request for a transportation service including one seat for another user, a request for a transportation service including more than one seat—one for the first user and one for the secondary user, etc.). In such a case, the request can include plus-one data for the at least one secondary user (e.g., the second user) of the transportation service.

The plus-one data can include data indicative of the second user. For example, plus-one data can include communication information for the second user such that the operations computing system can communicate and/or interact with the second user. The communication information, for example, can include an identifier for the second user (e.g., a unique identifier indicative of a user account (e.g., an account number) on the transportation service platform, etc.). By way of example, the communication information can be associated with a second user device associated with the second user. The second user device can include a software application associated with the transportation service platform running on the second user device (e.g., a second user software application). In some implementations, this software application can be associated with a second user account of the transportation service platform. In such a case, the communication information can include an account identifier associated with the second user account such that the operations computing system can communicate with the second user through the software application running on the second user device.

In addition, or alternately, the communication information can include contact data such as an email address and/or a phone number of the second user. The second user device can be associated with this contact data. For example, the second user device can be a mobile phone associated with the phone number of the second user and/or the first user device can include an email application that utilizes the second user's email address. As such, the communication information can include contact data such that the operations computing system can communicate with the second user via the second user device using the phone number (e.g., via text message, call, etc.), email address (e.g., via email message), etc.

The plus-one data can be received at any time before and/or during the transportation service. For example, as described in further detail below, the operations computing system can generate a multi-modal transportation itinerary for the first user and/or the second user of the transportation service. The multi-modal transportation itinerary can include one or more transportation legs. In some implementations, the plus-one data can be received before the generation of the multi-modal transportation itinerary (e.g., during the service request such as, for example, before a booking of a vehicle for the first itinerary leg, before aerial vehicle seat reservation/assignment, etc.). In some implementations, the plus-one data can be received during one or more legs of the multi-modal itinerary (e.g., during a first leg before arriving at the beginning of a second leg, etc.).

A first multi-modal transportation itinerary can be generated based on the request for the transportation service from the first user. The first multi-modal transportation itinerary can include two or more transportation legs (e.g., a first transportation leg, a second transportation leg, a third transportation leg, etc.) between an origin and destination location specified in the request. The two or more transportation legs can include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles. In some implementations, one or more vehicles can be provided by a vehicle provider so that the vehicle(s) can be utilized by the transportation platform for the provision of transportation services for one or more legs.

The operations computing system can facilitate the ability of the first and/or second user to receive transportation via one or more of the transportation legs included in the itinerary. As an example, the operations computing system can interact with the transportation platform/one or more ride-sharing networks to match the first and/or second user with one or more transportation service providers. In some implementations, the operations computing system can book or otherwise reserve a seat in, space on, and/or usage of one or more of the transportation modalities for the first and/or second users.

Additionally, or alternatively, the operations computing system can provide information (e.g., to the first and/or second user, etc.) for options to be provided by one or more third parties for one or more of the transportation legs. For example, in response to the first user's request, the operations computing system can utilize one or more algorithms/machine-learned models to generate an itinerary for the first and/or second user. As an example, in some implementations, the operations computing system can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first). By way of example, the operations computing system can assign the first user (and second user) to an aircraft for the middle leg of a three-leg multi-modal itinerary and, then, book a human-driven or autonomous ground-based vehicle for a first leg of the multi-modal itinerary to take the user(s) from an origin location to a first aircraft facility (e.g., to board the aircraft). At a later time (e.g., while the user(s) are in flight), the operations computing system can book another human-driven or autonomous ground-based vehicle to take the user(s) from a second aircraft facility to the specified destination location(s). In this manner, the operations computing system can generate a first multi-modal transportation itinerary for completing the transportation service.

The operations computing system can utilize the first multi-modal transportation itinerary as a basis for an itinerary for the second user. For instance, the operations computing system can generate the first multi-modal transportation itinerary for the first user and assign the first multi-modal transportation itinerary to the first user of the transportation platform. Upon receiving the plus-one data, the operations computing system can supplement the first multi-modal transportation itinerary with the data indicative of the second user. By way of example, the operations computing system can associate the second user with the first multi-modal transportation itinerary. In addition, or alternatively, the operations computing system can assign the first multi-modal transportation itinerary to the second user. In this manner, the first user and second user can be associated with the same multi-modal transportation itinerary (e.g., the first multi-modal transportation itinerary).

In some implementations, the operations computing system can determine a second multi-modal transportation itinerary for facilitating the aerial transport for the second user. For example, the second multi-modal transportation itinerary can include a different multi-modal transportation itinerary than the itinerary associated with the user (e.g., with a different itinerary identifier, etc.). The second multi-modal transportation itinerary can include the same and/or different information than the first multi-modal transportation itinerary. For example, the second multi-modal transportation itinerary can at least initially match the first multi-modal transportation itinerary. By way of example, the operations computing system can generate a second multi-modal transportation itinerary for the second user that mirrors the first multi-modal transportation itinerary associated with the user and store the second multi-modal transportation itinerary in an accessible database. This can enable, for example, a change to one itinerary without affecting the other itinerary. In addition, or alternatively, the second multi-modal transportation itinerary can include one or more different transportation legs than the first multi-modal transportation itinerary. For example, the plus-one data can include a different origin and/or destination than the request for the transportation service. In such a case, a new multi-modal transportation itinerary can be generated for the second user based on the different origin and/or destination. In this manner, a second multi-modal transportation itinerary can be generated that mirrors the first multi-modal transportation itinerary associated with the first user in all respects but for a modified transportation leg and/or other features specific to the second user (e.g., seat assignments, luggage, payload, etc.).

In addition, or alternatively, the first multi-modal transportation itinerary can include multiple first, second, third, etc. legs for the transportation service. For example, the operations computing system can add an additional first leg to the first multi-modal transportation itinerary in response to receiving plus-one data including another origin location different from the origin location of the request for the transportation service. This can allow the operations computing system to, for example, book a ground-based vehicle to pick-up the first user from a first origin and another ground-based vehicle to pick-up the second user from a second origin, both travelling to the same aircraft facility for the users to board the same aerial vehicle for aerial transport. The same can done for any leg of the first multi-modal transportation itinerary based on the plus-one data.

The operations computing system can customize which itinerary data is available (e.g., accessible, viewable) to the first user and which itinerary data is available to the second user. For example, as described herein, the operations computing system can generate itinerary data indicative of the first and/or second multi-modal transportation itinerary. The itinerary data, for example, can include a subset of information (e.g., identifier, destination location, type of travel, etc.) about the first and/or second multi-modal transportation itinerary that is available to the first user (e.g., via a first user device) and/or a subset of information about the first and/or second multi-modal transportation itinerary that is available to the second user (e.g., via a second user device). For instance, the operations computing system can generate “user itinerary data” that includes information accessible by the first user. For example, the operations computing system can generate the user itinerary data for the first user based one or more characteristics (e.g., as indicated by the first user's account, the request for the transportation service, etc.).

Additionally, or alternatively, the operations computing system can generate “passenger itinerary data” that includes information accessible by the second user. The operations computing system can generate passenger itinerary data for the second user based on the plus-one data and/or the first and/or second multi-modal transportation itinerary(s). The passenger itinerary data can be indicative of one or more portions of the first and/or second multi-modal transportation itinerary. By way of example, the passenger itinerary data can include an itinerary identifier. The itinerary identifier can include, for example, an itinerary serial number, barcode, etc. unique to the respective itinerary. For instance, the itinerary identifier can be used to look up the itinerary (e.g., via a web browser, a first/second software application, etc.). In addition, or alternatively, the itinerary identifier can include a link to more information (e.g., reachable via a web browser, a first/second software application, etc.) about the respective itinerary. Moreover, in some implementations, the itinerary identifier can include information about the transportation platform. For example, in the event the second user does not have an account with the service entity's transportation platform, the passenger itinerary data can include information on how to create an account, an option to join the transportation platform, a discount, etc. In this manner, the operations computing system can enable the second user to view information pertaining to portions of the first and/or second multi-modal transportation itinerary(s).

The passenger itinerary data can include data indicative of at least one of the transportation legs of the multi-modal transportation booked for the user(s). For example, the passenger itinerary data can include an overview of the first and/or second multi-modal transportation itinerary. By way of example, the passenger itinerary data can include an origin and destination location, mode of transportation, a start and arrival time, a seat assignment, etc. for each leg of the first and/or second multi-modal transportation itinerary. In addition, or alternatively, the passenger itinerary data can include detailed information for at least one transportation leg. By way of example, the passenger itinerary data can include a boarding pass for an aerial transportation leg of the at least two transportation legs. The boarding pass can include, for example, a seating assignment, terminal, flight number, security information, etc. for the aerial transportation leg of the first and/or second multi-modal transportation itinerary.

In some implementations, the passenger itinerary data can include the same information as the user itinerary data. For example, the operations computing system can be configured to communicate user itinerary data to the first user device associated with the first user. The user itinerary data can include information for each of the transportation legs of the first and/or second multi-modal transportation itinerary. In some implementations, the passenger itinerary data can mirror the user itinerary data such that the first and second user have access (e.g., via the first and second user devices, respectively) to the same information for the first and/or second multi-modal transportation itinerary.

In addition, or alternatively, the passenger itinerary data can be different than the user itinerary data. For example, as described above, the passenger itinerary data can provide less information of the first and/or second multi-modal transportation itinerary than user itinerary data. For example, the passenger itinerary data can include an abbreviated version of the multi-modal transportation itinerary information viewable by the first user (e.g., the information included in the user itinerary data). Additionally, in some implementations, the passenger itinerary data can be indicative of second multi-modal transportation itinerary information, whereas the user itinerary data can be indicative of at least a first multi-modal transportation itinerary information. For example, the user itinerary data can include information about the first and second multi-modal transportation itinerary, whereas the passenger itinerary data can be limited to information about the second multi-modal transportation itinerary. As another example, the user itinerary data can be limited to information about the first multi-modal transportation itinerary and the passenger itinerary data can be limited to the information about the second multi-modal transportation itinerary. In this manner, the operations computing system can generate data indicative of a subset of information included in the first and/or second multi-modal transportation itinerary specific to the first and/or second user.

For example, the passenger itinerary data can be indicative of first and/or second multi-modal transportation itinerary information relevant to the second user, whereas the user itinerary data can be indicative of first and/or second multi-modal transportation itinerary information relevant to the first user. By way of example, the passenger itinerary data can include an indication of the second user within a representation of the first and/or second multi-modal transportation itinerary (e.g., to illustrate the progress of the second user through the first and/or second multi-modal transportation itinerary), whereas the user itinerary data can include an indication of the first user within a representation of the first and/or second multi-modal transportation itinerary (e.g., to illustrate the progress of the first user through the first and/or second multi-modal transportation itinerary).

In some implementations, the operations computing system can modify the passenger itinerary data before and/or during the transportation service. For example, the passenger itinerary data can be modified based on a status (e.g., progress) of the second user through the first and/or second multi-modal transportation itinerary. For instance, the operations computing system can identify a passenger status of the second user. The passenger status can include the second user's location relative to the first and/or second multi-modal transportation itinerary. The passenger status can include an indication of a current transportation leg within which the second user is travelling and the progress of the second user through the current transportation leg. By way of example, the passenger status can indicate that the second user has yet to begin, is currently travelling along, and/or has completed a transportation leg of the first and/or second multi-modal transportation itinerary.

The operations computing system can modify the passenger itinerary data to include relevant information (e.g., driver name, pilot name, type of vehicle, etc.) for a transportation leg of the first and/or second multi-modal transportation itinerary based on the second user's progress along the first and/or second multi-modal transportation itinerary (e.g., as indicated by the passenger status). In this manner, the passenger itinerary data can be tailored to provide the second user with the most relevant data based on the second user's location within the first and/or second multi-modal transportation itinerary. For example, the operations computing system can periodically communicate messages indicative of the trip progress to the second user device.

As briefly discussed above, the passenger itinerary data indicative of the first and/or second multi-modal transportation itinerary can be communicated (e.g., by the operations computing system) to the second user device associated with the second user. For example, the passenger itinerary data can be communicated to the second user device based on the plus-one data (e.g., contact data such as account number, phone number, etc.). The second user device, for example, can include any type of computing device such as a smartphone, tablet, hand-held computing device, wearable computing device, embedded computing device, navigational computing device, etc. The second user device can include one or more communication interfaces (e.g., email client, second user software application, etc.) configured to communicate (e.g., via one or more networks such as local area networks, wide area networks, the Internet, secure networks, cellular networks, mesh networks, etc.) with the transportation platform.

In some implementations, the second user can update the first and/or second multi-modal transportation itinerary. For example, the operations computing system can receive a user update request for a change to the first and/or second multi-modal transportation itinerary from the second user device associated with the second user. The user update request can include at least one of supplemental itinerary data and/or itinerary modification data.

The supplemental itinerary data, for example, can be indicative of supplemental information for the first and/or second multi-modal transportation itinerary. By way of example, the supplemental information can include passenger preferences (e.g., seating, climate, music, etc.), passenger characteristics (e.g., weight, height, disabilities, etc.), passenger security information (e.g., passport/license details, flight clearances such as CLEAR, TSA precheck, etc.), passenger flexibility (e.g., willingness to delay, rebook, etc. the transportation service), passenger feedback (e.g., driver reviews, pilot reviews, etc.), etc. The itinerary modification data, for example, can be indicative of a requested modification to the first and/or second multi-modal transportation itinerary. By way of the example, the itinerary modification data can include ride modifications (ride cancellation, alternate pick-up/drop-off locations, etc.), ride confirmations (check-in, confirmation of pick-up, confirmation of drop-off, etc.), modification to seating arrangements, etc.

The operations computing system can update the first and/or second multi-modal transportation itinerary based on the user update request. For example, the operations computing system can update the first and/or second multi-modal transportation itinerary by supplementing the first and/or second multi-modal transportation itinerary with the supplemental data. By way of example, the operations computing system can add second user details to the first and/or second multi-modal transportation itinerary based on the supplemental data. For instance, the operations computing system can update the first and/or second multi-modal transportation itinerary by adding flight clearance details such as a TSA precheck clearance as specified by the second user (or an account associated with the second user) in the supplemental data. In this manner, the second user can update the first and/or second multi-modal transportation itinerary to include information specified by the second user.

In addition, or alternatively, the operations computing system can update the first and/or second multi-modal transportation itinerary by modifying one or more transportation legs of the itinerary based on the itinerary modification data. By way of example, the itinerary modification data can be indicative of a second user request to change an origin location for a first transportation leg of the first and/or second multi-modal transportation itinerary. In such a case, the operations computing system can modify the first transportation leg to schedule a transportation service provider to pick up the second user at the new origin location (e.g., redirect a currently scheduled transportation service provider, schedule a new transportation service provider, etc.).

In some implementations, the first and/or second user's ability to update the first and/or second multi-modal transportation itinerary can be based, at least in part, on the first and/or second user's status (e.g., location) within the first and/or second multi-modal transportation itinerary. For instance, the availability to update a transportation leg of the first and/or second multi-modal transportation itinerary can depend on the progress of the first and/or second user through the first and/or second multi-modal transportation itinerary. By way of example, an update to a transportation leg of the multi-modal transportation itinerary can become unavailable once the first and/or second user has begun the transportation service assigned for that leg.

Moreover, in some implementations, the first user can update the first and/or second multi-modal transportation itinerary based at least in part on an interaction or desired interaction with the second user. For instance, the first user and/or second user can desire to split a price of the transportation service between the users and/or change a weight allocation between users (e.g., to accommodate the second user's heavier luggage, etc.). The operations computing system can receive user interaction data from the first user (e.g., via the first user device) and/or the second user (e.g., via the second user device). The user interaction data can include an indication to split a price/reward associated with the first and/or second multi-modal transportation itinerary, an indication to allocate weight allowances (e.g., baggage allowance, etc.) associated with the first and/or second multi-modal transportation itinerary, etc. The operations computing system can receive the interaction data and update the first and/or second multi-modal transportation itinerary in accordance with the interaction data by, for example, splitting a price associated with a transportation service associated with the first and/or second transportation itinerary, adjusting the payload allocation so that the second user is afforded a heavier payload allowance, etc.

In some implementations, the operations computing system can determine whether to update the first and/or second multi-modal transportation itinerary in response to obtaining the user interaction data and/or the user update request based on the timing of the plus-one data. For instance, the operations computing system can update different transportation legs of the first and/or second multi-modal transportation itinerary based on the user interaction data and/or the user update request based on the second user's status at the time the plus-one data is received. By way of example, the operations computing system can be configured to ignore requests to modify a transportation leg of first and/or second multi-modal transportation itinerary after the second user begins and/or finishes the transportation leg.

In addition, or alternatively, the operations computing system can generate passenger itinerary data and/or update the first and/or second multi-modal transportation itinerary based on a privilege level associated with the first and/or second user. For example, the second user can be associated with a privilege level indicative of a level of control over the first and/or second multi-modal transportation itinerary. By way of example, the privilege level can be one of a plurality of privilege levels. Each respective privilege level can be indicative of a respective level of control over a multi-modal transportation itinerary. Control over a multi-modal transportation itinerary can include, for example, an ability to view one or more details of the itinerary, an ability to supplement the itinerary, an ability to modify the itinerary, an ability to interact with another user associated with the itinerary, etc.

For instance, the second user's control over an itinerary can range from having no control (e.g., no ability to view details, provide information to, modify, etc.) to the same control over the itinerary as that of the first user. By way of example, the first user can have full control (e.g., to view, edit, supplement, etc.) over the itinerary generated in response to the first user's request. In some implementations, the second user can share the same control as the first user that requested the transportation service.

More particularly, a first privilege level can be indicative of a complete lack of control over an itinerary. A second user associated with this first privilege level can be associated with an itinerary but prohibited from viewing details of or modifying the itinerary. A second privilege level can be indicative of viewable control over an itinerary. For example, the second privilege level can indicate that the second user is an observer of the itinerary. For instance, the operations computing system can provide up-to-date passenger itinerary data to a second user device associated with the second privilege level but ignore any update request received from the second user device. A third privilege level can be indicative of an intermediate level of control over an itinerary. For example, the operations computing system can provide up-to-date passenger itinerary data to a second user device associated with the third privilege level, supplement the itinerary based on supplemental itinerary data received from the second user device, but ignore any request to modify the itinerary received from the second user device. As a fourth example, a fourth privilege level can be indicative of complete control over the itinerary. For instance, the operations computing system can provide up-to-date passenger itinerary data to a second user device associated with the fourth privilege level, supplement the itinerary based on supplemental itinerary data received from the second user device, and modify the itinerary based on itinerary modification data received from the second user device. The fourth privilege level can be beneficial, for example, when a first user requests a transportation service for a second user that does not include a seat for the first user. In such a case, the second user can be assigned a fourth privilege level identifying the second user as the primary owner of the itinerary.

In some implementations, the first user can specify or request the privilege level associated with the second user. For instance, the plus-one data can include priority data indicative of the privilege level associated with the second user. The first user can provide priority data to the operations computing system with the plus-one data (e.g., when generating a request for transportation). The priority data can include a desired level of control for the second user over the itinerary as specified by the first user. In this manner, the priority data can be dynamically set, via the first user device, by the first user. In addition, or alternatively, a second user can be assigned a default passenger privilege level (e.g., the first privilege level, second privilege level, etc.) that is assigned to all second users associated with a multi-modal transportation itinerary.

In some implementations, the operations computing system can assign a privilege level to a second user based at least in part on the second user's relationship to the transportation platform. By way of example, a second user that is not associated with an account on the transportation platform can be assigned (e.g., by default) the first privilege level indicative of a complete lack of control over the first and/or second multi-modal transportation itinerary, whereas a second user associated with an account can be assigned (e.g., by default) a privilege level higher than the first privilege level. In addition, or alternatively, where the second user is associated with a user account, the operations computing system can assign a privilege level to the second user based on characteristics (e.g., user rating, usage levels, age, etc.) of the second user's account. For instance, a second user associated with a user rating at or above a rating threshold can be assigned a higher privilege level (e.g., the fourth privilege level) than a second user associated with a user rating below the rating threshold (e.g., assigned the third privilege level). In this respect, a second user associated with a new account and/or an account with a low usage rate (e.g., as indicated by an age or history of use associated with the account) can be assigned a lower privilege level (e.g., a second privilege level) than a second user with an established account and/or a high usage rate (e.g., the third privilege level).

The operations computing system can identify the privilege level associated with the second user (e.g., based on timing, the plus-one data, default priority, etc.) and generate the passenger itinerary data based on the privilege level associated with the second user. For example, a privilege level can correspond to a level of detail of the first and/or second multi-modal transportation itinerary (e.g., the first privilege level can correspond to first level of detail, the second privilege level can correspond to a second, more in depth, level of detail, etc.). The operations computing system can generate passenger itinerary data based on the privilege level by reducing the level of detail for a lower privilege level and increasing the level of detail for a higher privilege level. For instance, the operations computing system can generate passenger itinerary data indicative of an overview of the first and/or second multi-modal transportation itinerary for a lower privilege level (e.g., a second privilege level) and passenger itinerary data indicative of a detailed overview of each transportation leg of the first and/or second multi-modal transportation itinerary for a higher privilege level (e.g., a fourth privilege level). The operations computing system can communicate the passenger itinerary data to the second user device based on the privilege level associated with the second user. In this manner, the operations computing system can control the second user's ability to view details of the first and/or second multi-modal transportation itinerary based on a privilege level associated with the second user.

In some implementations, the operations computing system can identify the privilege level associated with the second user (e.g., based on timing, the plus-one data, default priority, etc.) and determine whether to update the first and/or second multi-modal transportation itinerary based on the privilege level associated with the second user. For example, the operations computing system can determine whether the privilege level is above a threshold privilege level before updating the first and/or second multi-modal transportation itinerary in response to a user update request from the second user. For instance, the supplemental itinerary data can be associated with a first threshold privilege level (e.g., the third privilege level). In addition, or alternatively, the itinerary modification data can be associated with a second threshold privilege level (e.g., the fourth privilege level). In some implementations, the first threshold privilege level can be lower than the second threshold privilege level.

The operations computing system can determine whether the privilege level is above the first threshold privilege level or the second threshold privilege level and can update the first and/or second multi-modal itinerary based on the determination of whether the privilege level is above the first threshold privilege level and/or the second threshold privilege level. For example, the operations computing system can update the first and/or second multi-modal transportation itinerary in the event that the user update request includes supplemental itinerary data and the second user is associated with a privilege level at or above the first threshold privilege. As another example, the operations computing system can ignore a user update request in the event that the user update request comprises supplemental itinerary data and the second user is associated with a privilege level below the first threshold privilege level. In this manner, the operations computing system can limit the control of the second user over the first and/or second multi-modal transportation itinerary based on a privilege level associated with the second user.

Example aspects of the present disclosure can provide a number of improvements to computing technology such as, for example, multi-modal transportation computing technology. For instance, the systems and methods of the present disclosure provide an improved approach for communicating with secondary users of a transportation service that do not request the service. For example, a computing system can obtain a request for a transportation service that includes at least an aerial transport of a first user. The request can be generated via a first user device associated with the first user. The computing system can generate a first multi-modal transportation itinerary for facilitating the aerial transport for the first user. The itinerary can include at least a first transportation leg, a second transportation leg, and a third transportation leg. The computing system can obtain data indicative of a second user that is to travel with the first user for at least a portion of the multi-modal transportation and determine a second multi-modal transportation itinerary for facilitating the aerial transport for the second user. The second multi-modal transportation can at least initially match the first multi-modal transportation itinerary. The computing system can communicate passenger itinerary data indicative of the second multi-modal transportation itinerary to a second user device associated with the second user. In this manner, the present disclosure presents an improved computing system that can effectively monitor and interact with a secondary user of a transportation service. For example, the computing system employs an improved user interface that can accept communication information for the secondary user. As a result, the computing system can accumulate and utilize newly available information such as, for example, communication information to better facilitate multi-modal transportation services for a first and second user of the transportation service. In this way, the computing system provides a practical application that enables a first user to book a transportation service for a second user and interact with the second user once booked. The computer-implemented techniques disclosed herein result in seamless secondary user engagement within a transportation service scheduled by another user.

Additionally, the technology of the present disclosure can improve efficiency the of computing resources underlying the transportation platform. For example, the computing systems, as described, can utilize a first itinerary as a basis for generating an itinerary for a second user. This can allow the computing systems to avoid utilizing additional processing and memory resources on creating a multi-modal itinerary for the second user from scratch based on the optimization operations described herein. Ultimately, this can allow the computing systems to instead utilize these additional computational resources on improved monitoring, more efficient contingencies planning, better itinerary adjustment, quickly refreshing user interfaces, etc.

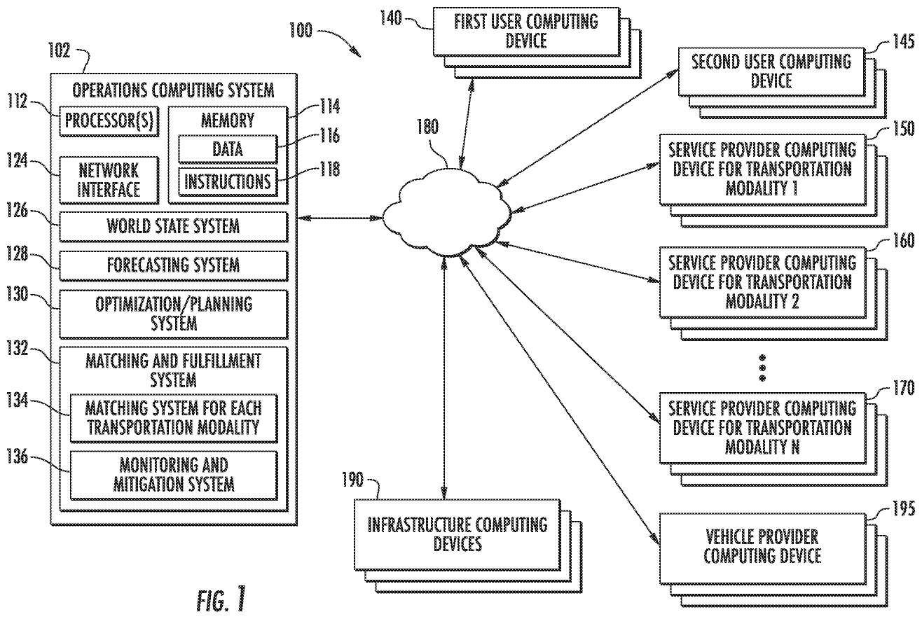

With reference now to the FIGS. 1-10, example embodiments of the present disclosure will be discussed in further detail.

FIG. 1 depicts a block diagram of an example computing system 100 according to example implementations of the present disclosure. The computing system 100 includes an operations computing system 102 (e.g., a cloud-based operations computing system, etc.) that can operate to plan and fulfill multi-modal transportation service itineraries. The operations computing system 102 can be communicatively connected over a network 180 to one or more first user computing device(s) 140, one or more second user computing devices 145, one or more service provider computing devices 150 for a first transportation modality, one or more service provider computing devices 160 for a second transportation modality, one or more service provider computing devices 170 for an Nth transportation modality, one or more infrastructure computing devices 190, and one or more vehicle provider computing devices 195.

Each of the computing devices 140, 150, 160, 170, 190, 195 can include any type of computing device such as a smartphone, tablet, hand-held computing device, wearable computing device, embedded computing device, navigational computing device, vehicle computing device, laptop, desktop, server system, etc. A computing device can be associated with a computing system. A computing device can include one or more processors and a memory (e.g., similar to as will be discussed with reference to processors 112 and memory 114). Although service provider devices are shown for N different transportation modalities, any number of different transportation modalities can be used, including, for example, less than the three illustrated modalities (e.g., two modalities can be used).

The operations computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the operations computing system 102 can obtain data from one or more memory device(s) that are remote from the system 102.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112. For example, the memory 114 can store instructions 118 that when executed by the one or more processors 112 cause the one or more processors 112 to perform any of the operations and/or functions described herein.

In some implementations, the operations computing system 102 can facilitate the ability of the user to receive transportation on one or more of the transportation legs included in an itinerary. As one example, the operations computing system 102 can implement and/or interact with one or more ride-sharing networks to match the user with one or more transportation service providers 150, 160, 170. As another example, the operations computing system 102 can book or otherwise reserve a seat in, space on, or usage of one or more of the transportation modalities for the user. Additionally, or alternatively, the operations computing system 102 can simply provide information for options to be provided by one or more third parties for one or more of the transportation legs.

More particularly, the operations computing system 102 can be associated with a service entity and be configured to manage, coordinate, and dynamically adjust a multi-modal transportation service via a transportation platform of the service entity. The service entity can include, for example, a transportation network provider. The transportation network provider can be an entity that coordinates, manages, etc. transportation services that include aerial and/or other types of vehicles. The transportation network provider can be associated with one or more transportation platforms. A transportation platform can be utilized for the provision of transportation services via one or more vehicles available, online, etc. to the transportation platform. In some implementations, the vehicles used to provide the transportation services can be owned, operated, leased, etc. by the service entity (e.g., the transportation network provider). Additionally, or alternatively, the vehicles the vehicles used to provide the transportation service be owned, operated, leased, etc. by an entity other than the service entity (e.g., a third party vehicle provider).

The multi-modal transportation service can include a plurality of transportation legs, one of which (e.g., a second transportation leg) can include an aerial transport of a user. For example, the operations computing system 102 can obtain a request for a transportation service. The request for the transportation service can include at least a request for an aerial transport of a user of a transportation platform. The operations computing system can obtain the request from a first user computing device 140 associated with the first user of the transportation platform. The first user device 140, for example, can include any type of computing device such as a smartphone, tablet, hand-held computing device, wearable computing device, embedded computing device, navigational computing device, etc. The first user device 140 can include one or more communication interfaces configured to communicate via network 180 (e.g., via one or more networks such as local area networks, wide area networks, the Internet, secure networks, cellular networks, mesh networks, etc.) with the transportation platform (e.g., operations computing system 102).

In some implementations, the first user device 140 can generate the request. For instance, the first user device 140 can include a first software application running on the first user device 140. The first software application, for example, can be associated with the first user and/or the transportation platform. For example, the first user can be associated with an account on the transportation platform and the first software application can allow the first user to book a multi-model transportation service of the service entity using the first user's account (e.g., to facilitate payment, maintain usage history, apply discounts, identify preferences, etc.). The first user can interact with the first software application running on the first user device 140 (e.g., via a user interface) to generate the request for the transportation service.

A transportation platform, for example, can include cloud services system communicatively connected over a network to a plurality of users (e.g., via one or more first user devices 140, one or more second user device 145, etc.), a plurality service providers (e.g., via one or more service provider devices 150, 160, 170, etc.), etc. The transportation platform can be configured to leverage transportation capabilities of the plurality of service providers to schedule and facilitate a multi-modal transportation service for the plurality of users (and/or one or more secondary users associated with the plurality of users). The operations computing system 102 can be configured to coordinate multi-modal transportation for the transportation platform.

For example, the operations computing system 102 can respond to a first user's request by determining whether it is better to fulfill the first user's request using a single transportation modality or using multiple transportation modalities. As one example, the operations computing system 102 can evaluate the first user and/or a secondary user's current location, request origin, and/or destination to determine which modalities of transportation are usable at such location (e.g., able to access such locations). For example, the location(s) can be checked against a list of white listed locations that have been approved for participation in various types of modalities (e.g., flight modalities for the purpose of generating a multi-modal trip itinerary). As another example, the operations computing system 102 can evaluate (e.g., generate) one or more itineraries that are single-modal and one or more itineraries that a multi-modal (e.g., inclusive of various combinations of different transportation modalities). The operations computing system 102 can compare the generated single- and multi-modal itineraries to determine whether it is appropriate to suggest a single- or multi-modal itinerary to the first and/or secondary user. For example, one or more of the best itineraries (e.g., as evaluated based on various characteristics such as cost, time, etc.) can be suggested to the first and/or secondary user. The first and/or secondary user can select one of the suggested itineraries to receive transportation services in accordance with the selected itinerary.

In addition, in some implementations, the operations computing system 102 can continually re-evaluate various itineraries (e.g., single- and/or multi-modal itineraries) before and even during completion of a selected itinerary. If an improved itinerary becomes available (e.g., which may include changing from a single-modal itinerary to a multi-modal itinerary if, for example, a seat on a flight becomes available) the operations computing system 102 can suggest the improved itinerary for selection by a first user and/or a secondary user. In some implementations, if the first and/or secondary user selects the improved itinerary during completion of an existing itinerary, the operations computing system 102 can facilitate switching to the updated itinerary, including, for example, re-routing a transportation provider that is currently transporting the first and/or secondary user to an alternative, updated destination.

In some implementations, the operations computing system 102 can include and implement logic for handling transportation service provider cancellations and/or inappropriate usage (e.g., “gaming”) of the ride sharing network by the transportation service provider. As one example, in the event of a service provider cancellation or if the service provider is not making substantial progress toward fulfilling the requested, the operations computing system 102 can automatically prompt a re-handling of the user's request (e.g., re-match to a different service provider but using the same itinerary). Alternatively, or additionally, the operations computing system 102 can automatically create a new request and perform the itinerary creation process an additional time (e.g., in the case that leg(s) of the original itinerary are accepted by a matched service provider but not fulfilled).

In addition, or alternatively to service provider cancellations, the operations computing system 102 can include and implement logic for handling user cancellations. As one example, if the first and/or secondary user cancels the transportation request/itinerary prior to the scheduled time of pickup and/or actual pickup for the initial transportation leg, the operations computing system 102 can cancel the entire trip/itinerary. As another example, if a transportation service provider has already been matched for the initial leg, a first cancellation by the first and/or secondary user can be treated as a request to re-match the first and/or secondary user for the initial transportation leg. A second cancellation by the first and/or secondary user can then result in the entire trip/itinerary being cancelled. This logic which interprets the first cancellation as a re-match request avoids cancelling the entire trip when the first and/or secondary user is simply cancelling the match with the first service provider because the first service provider is not making substantial progress toward completing the transportation service (e.g., service provider's vehicle is not moving toward the pickup location).

According to another aspect of the present disclosure, in some implementations and scenarios, the operations computing system 102 can disable the ability of a transportation service provider to contact the first and/or secondary user. In particular, one possible scenario is that the first and/or secondary user is currently being transported via flight-based transportation. During flight, the first and/or secondary user may have been matched with a ground-based transportation provider. The ground-based transportation provider may arrive at the transfer point (e.g., a destination transportation node) in advance of the first and/or secondary user's flight and begin contacting the first and/or secondary user (e.g., via phone call or text message) asking the first and/or secondary user of their location and if the first and/or secondary user is ready to engage in the ground-based transportation service. This can be a frustrating or otherwise undesirable experience for the first and/or secondary user as the first and/or secondary user may feel as though they are delaying the ground-based transportation service provider and/or being rushed by the ground-based transportation service provider but, because they are currently on the flight, the user is unable to take action to reduce the time until the ground-based service can be engaged. Thus, to prevent this scenario, the operations computing system 102 may disable a ground-based service provider's ability to contact the first and/or secondary user if the ground-based service is being provided following a flight-based transportation leg and the flight-based transportation leg has not yet completed. Once the flight-based transportation leg has completed, the service provider may be re-enabled to contact the first and/or secondary user. In some implementations, the operations computing system 102 can provide the first and/or secondary user with status updates to keep the first and/or secondary user informed despite disabling the service provider's ability to contact the first and/or secondary user (e.g., “John has arrived and is ready to take you to your destination”). In some implementations, the operations computing system 102 can provide the service provider with status updates to keep the service provider informed despite disabling the service provider's ability to contact the first and/or secondary user (e.g., “Jane's flight is delayed by 5 minutes” or “Jane's flight will arrive in 7 minutes”).

In some implementations, the operations computing system 102 can perform one or more mitigation processes or routines to mitigate failure of one or legs of transportation in a multi-leg transportation itinerary. As one example, a mitigation process implemented by the operations computing system 102 can include and implement logic for responding to cancellations of flights on which a first and/or secondary user is booked. As one example, if a planned flight is cancelled and the first and/or secondary user has not yet initiated the itinerary or a threshold period before initiation of the itinerary has not yet been reached, then the operations computing system 102 can cancel the entire trip/itinerary. The first and/or secondary user can be notified of the cancellation and given an opportunity to re-submit the request for transportation. However, if the first and/or secondary user has already initiated the itinerary or a threshold period before initiation of the itinerary has been entered, the operations computing system 102 can notify the first and/or secondary user and offer to re-route (e.g., re-plan the trip with updated information, re-match for the transportation leg with an alternative service provider, and/or change that transportation leg to an alternative transportation modality) the first and/or secondary user. In some implementations, the re-routing operations can be given preference or preferential treatment (e.g., the first and/or secondary user's use of a luxury modality may be subsidized or reduced-fare).

In some implementations, when a multi-modal itinerary has been completed, the operations computing system 102 can provide the first and/or secondary user with a single receipt. The single receipt can detail respective portions of the final cost associated with each of the multiple legs of transportation. The operations computing system 102 can generate the single receipt by generating multiple receipts respectively for the multiple transportation legs and then stitching the multiple receipts to generate the single receipt.

The operations computing system 102 can include a number of different systems such as a world state system 126, a forecasting system 128, an optimization/planning system 130, and a matching and fulfillment system 132. The matching and fulfillment system 132 can include a different matching system 134 for each transportation modality and a monitoring and mitigation system 136. Each of the systems 126-136 can be implemented in software, firmware, and/or hardware, including, for example, as software which, when executed by the processors 112 cause the operations computing system 102 to perform desired operations. The systems 126-136 can cooperatively interoperate (e.g., including supplying information to each other).

The world state system 126 can operate to maintain data descriptive of a current state of the world. For example, the world state system 126 can generate, collect, and/or maintain data descriptive of predicted rider demand; predicted service provider supply; predicted weather conditions; planned itineraries; pre-determined transportation plans (e.g., flight plans) and assignments; current requests; current ground transportation service providers; current transportation node operational statuses (e.g., including re-charging or re-fueling capabilities); current aircraft statuses (e.g., including current fuel or battery level); current aircraft pilot statuses; current flight states and trajectories; current airspace information; current weather conditions; current communication system behavior/protocols; and/or the like. The world state system 126 can obtain such world state information through communication with some or all of the devices 140, 145, 150, 160, 170, 190, 195. For example, devices 140, 145 can provide current information about riders while devices 150, 160, 170, and 195 can provide current information about service providers. Devices 190 can provide current information about the status of infrastructure and associated operations/management.

The forecasting system 128 can generate predictions of the demand and supply for transportation services at or between various locations over time. The forecasting system 128 can also generate or supply weather forecasts. The forecasts made by the system 128 can be generated based on historical data and/or through modeling of supply and demand. In some instances, the forecasting system 128 can be referred to as an RMR system, where RMR refers to “routing, matching, and recharging.” The RMR system can be able to simulate the behavior of a full day of activity across multiple ride share networks.

The optimization/planning system 130 can generate transportation plans for various transportation assets and/or can generate itineraries for riders. For example, the optimization/planning system 130 can perform flight planning. As another example, optimization/planning system 130 can plan or manage/optimize itineraries which include interactions between riders and service providers across multiple modes of transportation.

The matching and fulfillment system 132 can match a rider with a service provider for each of the different transportation modalities. For example, each respective matching system 134 can communicate with the corresponding service provider computing devices 150, 160, 170 via one or more APIs or connections. Each matching system 134 can communicate trajectories and/or assignments to the corresponding service providers. Thus, the matching and fulfillment system 132 can perform or handle assignment of ground transportation, flight trajectories, take-off/landing, etc.

The monitoring and mitigation system 136 can perform monitoring of user itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the devices 140, 145, 150, 160, 170, 190, and 195. For example, riders, service providers, and/or operations personnel can be alerted when a certain transportation plan has been modified and can be provided with an updated plan/course of action. Thus, the monitoring and mitigation system 136 can have additional control over the movement of aircraft, ground vehicles, pilots, and riders.

In some implementations, the operations computing system 102 can also store or include one or more machine-learned models. For example, the models can be or can otherwise include various machine-learned models such as support vector machines, neural networks (e.g., deep neural networks), decision-tree based models (e.g., random forests), or other multi-layer non-linear models. Example neural networks include feed-forward neural networks, recurrent neural networks (e.g., long short-term memory recurrent neural networks), convolutional neural networks, or other forms of neural networks.

In some instances, the service provider computing devices 150, 160, 170 can be associated with autonomous vehicles. Thus, the service provider computing devices 150, 160, 170 can provide communication between the operations computing system 102 and an autonomy stack of the autonomous vehicle which autonomously controls motion of the autonomous vehicle.

The infrastructure computing devices 190 can be any form of computing device used by or at the infrastructure or operations personnel including, for example, devices configured to perform passenger security checks, luggage check in/out, re-charging/re-fueling, safety briefings, vehicle check in/out, and/or the like.

In some implementations, the system 100 can include one or more vehicle provider computing devices 195. The vehicle provider computing device(s) 195 can be associated with one or more vehicle providers. A vehicle provider can be an entity (e.g., a first party entity, third party entity, etc.) that operates, owns, leases, controls, manufactures, etc. one or more vehicles. For example, a vehicle provider can include an operator, vendor, supplier, manufacturer, etc. of one or more aircraft. Each vehicle provider can be associated with respective vehicle provider computing device(s) 195. The vehicle provider computing device(s) 195 can be configured to manage the vehicles associated with that vehicle provider. This can include, for example, overseeing itineraries, accepting/rejecting transportation services, suggesting candidate vehicles, overseeing maintenance, controlling online/offline status, etc. A vehicle provider computing device 195 can communicate with the operations computing system 102 directly and/or indirectly. A vehicle associated with a vehicle provider can communicate directly with the operations computing system 102 and/or indirectly via the vehicle provider computing device(s) 195 (e.g., acting as an intermediary, etc.).

The vehicle providers' vehicles that are available for transportation services can include one or more types of vehicles. For example, the vehicle provider(s) can include a plurality of aerial vehicle providers, where each vehicle provider can provide a different type of aircraft (e.g., VTOL, helicopter, etc.) and/or a different model of aircraft. In some implementations, a vehicle provider can provide more than one type, version, model, etc. of aircraft available for the operations computing system 102 and/or the service entity. The different types of aircraft can include different shapes, sizes, capacities, capabilities, parameters, autonomy abilities (e.g., autonomous, semi-autonomous, manual, etc.), landing gear, hardware, etc. Although the following describes vehicle providers as aerial vehicle providers, this is provided as an example only and is not intended to be limiting. For example, vehicle providers can include providers of other types of vehicles such as ground-based vehicles (e.g., cars, bicycles, scooters, etc.) and/or other modes of transportation.

The operations computing system 102 and the vehicle provider computing device(s) 195 can communicate information to one another. The vehicle provider computing device(s) 195 can communicate various types of information to the operations computing system 102. For example, the vehicle provider computing device(s) 195 can provide data indicative of: status information (e.g., online/offline status, on-trip status, vehicle availability for transportation service, etc.), acceptance and/or rejection of a service (e.g., an aerial transportation service, etc.), maintenance information, vehicle parameters (e.g., weight capacity, noise signature, number of seats, set configuration, flight hours, charging/refueling parameters, hardware, temperature control parameters, operational restrictions, etc.), flight schedules, candidate vehicles, locations, updates of any such information, etc. The operations computing system 102 can communicate various types of information to a vehicle provider device 195. For example, the operations computing system can provide data indicative of: transportation services (e.g., services needed, specific vehicle requests, etc.), vehicle itineraries, status information (e.g., service in progress, etc.), vehicle parameter updates, payloads, locations, user/passenger information (e.g., anonymized and securely protected, etc.), air traffic information, environmental data (e.g., expected wind speeds, weather information, etc.), and/or other types of information.

The service entity associated with the operations computing system 102 can utilize vehicles associated with various parties. In some implementations, the service entity can also be a vehicle provider (e.g., a first party entity, etc.). For example, the service entity can utilize vehicles (e.g., ground-based vehicles, aircraft, etc.) within the service entity's fleet that are online with the transportation platform, etc. Additionally, or alternatively, the service entity can utilize vehicles provided by a vehicle provider from the vehicle provider's fleet. A fleet can include one or a plurality of vehicles. A vehicle provider can make one or more of the vehicles in its fleet available to the service entity/operations computing system 102. For example, the vehicle provider computing device(s) 195 and/or a service provider computing device of a vehicle can log into a transportation platform, provide data indicating a vehicle is available, facilitate the vehicle being actively engaged with the transportation platform, and/or otherwise inform a service entity of a vehicle's availability. In some implementations, a vehicle provider computing device 195 can provide data indicative of vehicles that are not online with the service entity and that could or may become available.

The vehicles to be utilized for a particular multiple-modal transportation service can be determined in a variety of manners. The operations computing system 102 (and the associated service entity) may have varying levels of control over the vehicle(s) that perform its services. For example, a vehicle provider may make one or more vehicles available to the service entity. The service entity may be able to determine which vehicles are to perform which legs of a transportation without input from the vehicle provider. Thus, the service entity may have full control of the vehicles online with the platform.

In some implementations, the service entity may determine transportation service assignments for vehicles of the service entity, while a vehicle provider may be able to determine (e.g., accept, reject, etc.) transportation service assignments for its vehicles. For example, the operations computing system 102 can provide data indicative of a flight leg, itinerary, etc. to one or more vehicle provider computing devices 195. The data can indicate a request for a specific vehicle or a request for any available vehicle within the vehicle provider's available fleet to perform the transportation service (e.g., flight transportation between two vertiports, etc.). In some implementations, the data may include certain parameters (e.g., weight capacity, number of seats, noise parameters, etc.) needed and/or preferred by the service entity, user, etc. The vehicle provider computing device 195 can process this data and determine whether a specifically requested vehicle and/or another vehicle associated with the vehicle provider will provide the requested service (e.g., perform a flight for the second leg of a multi-model transportation service). The vehicle provider computing device 195 can communicate data indicative of the acceptance or rejection to the operations computing system 102. In some implementations, data indicative of the requested transportation service can be communicated to a service provider computing device 150, 160, 160 associated with a vehicle of a vehicle provider's fleet (e.g., an aircraft, etc.) and the service provider can accept or reject the service (e.g., the flight transportation, etc.).

In some implementations, one or more vehicle provider computing device(s) 195 can communicate data indicative of a plurality of candidate vehicles that could provide the requested service (e.g., perform an aerial transportation service for a flight leg). The operations computing system 102 can select from among the plurality of candidate vehicles and communicate data indicative of the selected candidate vehicle to the vehicle provider computing device(s) 195.

The operations computing system 102 can determine which vehicles are to perform which transportations legs in an on-demand manner or based at least in part on a schedule. For example, operations computing system 102 can initially generate a flight itinerary in response to receiving a first request. In some implementations, the operations computing system 102 can have a pre-determined flight schedule and offer aerial transport (e.g., for multi-modal transportation services, etc.) in the event that a user's time constraints and locations can be met with the pre-determined flight schedule.

In some implementations, the vehicle provider may provide initial input regarding vehicle scheduling. For example, the vehicle provider computing device 195 can communicate data indicative of a flight schedule for one or more aircrafts between various vertiports. The vehicle provider 195 can communicate initial seat availability, as well as updates throughout an operational time period (e.g., throughout a day, etc.), to the operations computing system 102. The operations computing system 102 can utilize this flight schedule to determine itineraries for users and/or vehicles of the transportation service. For example, the operations computing system 102 can use the flight schedule to determine whether to offer a multi-modal transportation service with an aerial leg to a user and/or to generate itineraries with aerial legs based on the flight schedule. In some implementations, the flight schedule can be an initial flight schedule for an operational time period. For example, the vehicle provider computing device(s) 195 can provide data indicative of the initial flights for the available vehicles at the beginning of a day. The operations computing system 102 can utilize this data to determine multi-modal transportation services at the beginning of the day. Thereafter, the operations computing system 102 can determine the flight itineraries in an on-demand manner to meet user/passenger demand throughout the operational time period.

Additionally, or alternatively, the operations computing system 102 can communicate data indicative of a schedule (e.g., initial, for full operational period, etc.) to the vehicle provider computing device(s) 195. The vehicle provider computing device(s) 195 can process the schedule and communicate data indicative of which vehicles (e.g., aircraft, etc.) are available for which services (e.g., flight legs, etc.).

In some implementations, the operations computing system 102 can communicate data indicative of a transportation service (e.g., one or more flight legs, schedules, etc.) to a plurality of vehicle provider computing device(s) 195. One or more of the vehicle provider computing device(s) 195 can process the data and communicate data indicative of vehicle(s) (e.g., aircraft, etc.) that are available to fulfill the transportation service (e.g., perform aerial transportation for one or more leg(s), etc.) to the operations computing system 102. In some implementations, the vehicle provider computing device(s) 195 can provide information indicative of vehicle parameters, costs/fees, etc. The operations computing system 102 can be configured to analyze the responses from the plurality of vehicle provider computing devices 195 to determine a service provider. For example, the operations computing system 102 can utilize rules, models, algorithms, etc. that weigh the various vehicle parameters to select an aircraft for a user to ensure that the user's estimated arrival times are not violated, to minimize costs, etc.

The vehicle provider computing device(s) 195 and/or the operations computing system 102 can communicate data indicative of the transportation service (e.g., flight itinerary data, etc.) to a service provider computing device 150, 160, 170, 195 associated with a vehicle. For example, a vehicle provider device 195 or the operations computing system 102 can communicate data indicative of a flight (e.g., times, locations, users, payload, etc.) to a computing device onboard an aircraft and/or a device of a pilot of the aircraft.

The network(s) 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

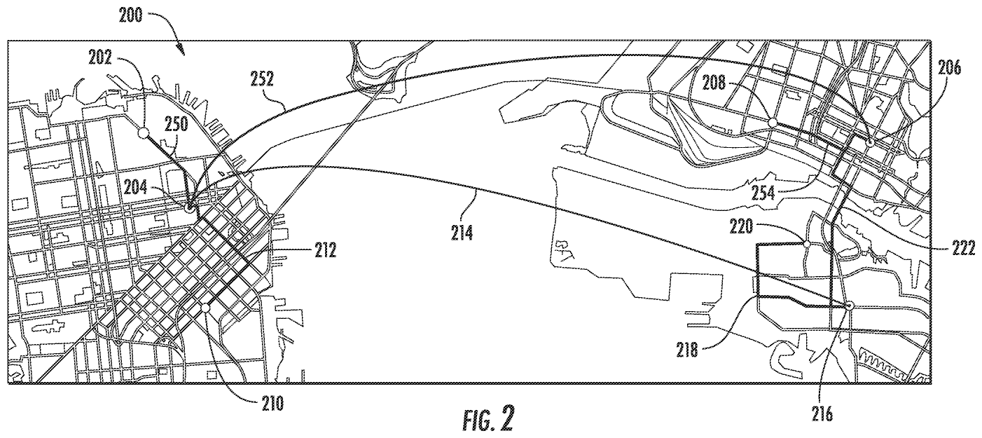

FIG. 2 depicts example multi-modal transportation itineraries 200 according to example implementations of the present disclosure. The itineraries 200 can include at least three transportation legs to transport a first and/or secondary user from a first origin 202 and/or 210 to a destination 208 and/or 220. In particular, the itinerary 200 includes at least one first, ground-based (e.g., car-based) transportation leg 212, 250 which transports the first and/or secondary user from the origin 202 to a departure transportation node 204; at least one second, flight-based transportation leg 214 and/or 252 which transports the first and/or secondary user from the departure transportation node 204 to an arrival transportation node 206 and/or 216; and at least one third, ground-based (e.g., car-based) transportation leg 218, 222, and/or 454 which transports the first and/or secondary user from the arrival transportation node(s) 206, 216 to the destination 208, 220.

For example, the operations computing system can obtain a request from a first user that requests the operations computing system to facilitate a transportation service for the first user and/or a second user from one or more origin locations 202, 210 to one or more destination locations 208, 220. In some instances, the first and second users can utilize the same origin and destination locations, while in other instances the first and second users may have different origin and/or destination locations from one another. By way of example, the first user can interact with the first software application running on the first user device to initiate the request. In some instances, unless specified otherwise, the origin of the transportation service can be assumed to be a current location of the first user (e.g., as indicated by location data such as GPS data received from the first user device and/or as input by the first user). The first user can also supply a desired destination (e.g., by typing the destination into a text field which may, for example, provide suggested completed entries while the first user types).

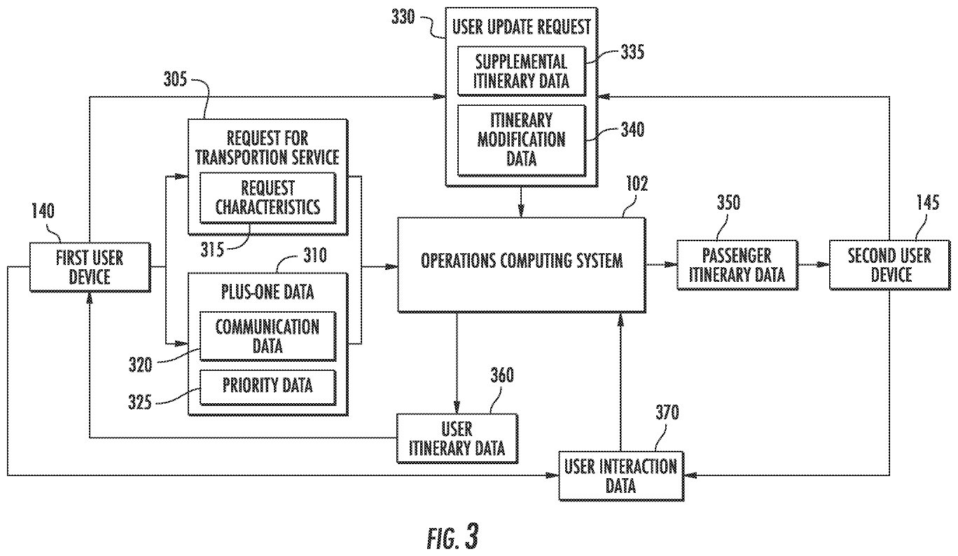

FIG. 3 depicts an example data flow diagram according to example implementations of the present disclosure. The operations computing system 102 can receive a request for a transportation service 305 and/or plus-one data 310 from a first user device 140 associated with a first user. In addition, or alternatively, the operation computing system 102 can receive user update request 330 and/or user interaction data 370 from a first and/or second user device 140, 145. In response, the operations computing system 102 can provide user itinerary data 360 to the first user device 140 and passenger itinerary data 350 to the second user device 145.

More particularity, the operations computing system 102 can receive a request for a transportation service 305 from the first user device 140. The request 305 can include request characteristics 315. For example, the request characteristics 315 can include the origin location and/or the destination location. In addition, the request 305 can also specify an “arrive by” date and time at which the first user desires to arrive at the requested destination. Thus, the first user can specify when the first user would like to arrive at the destination. In other implementations, the request 305 can indicate a “depart at” date and time that the first user would like to depart. In some examples, the “depart at” date and time can be assumed to be the current date and time unless specified otherwise. The first user can also provide entries for any number of additional characteristics that the first user would like the transportation service to meet. For example, request characteristics 315 can specify a required number of seats, a preferred vehicle type (e.g., luxury vs. economy, humanly-operated vs. autonomous, etc.), an estimated payload weight (e.g., passengers and/or luggage weight, etc.), a preferred payload capacity (e.g., so that the vehicle accommodates the weight of any luggage carried by the first user, etc.), maximum price, and/or various other characteristics.

In some implementations, the first user can provide passenger details for the transportation service. For instance, plus-one data 310 can be obtained in addition to the request for the multi-modal transportation service 305 (e.g., from the first user device). The plus-one data 310 can be associated with a second user of the transportation service. For example, the second user can include a user that is to travel with the first user for at least a portion of the transportation service. In addition, or alternatively, the second user can include a user for which the first user is booking the transportation service. Thus, the second user can include a user that is to use the transportation service with or without the first user. The second user can include another user of the transportation platform and/or a user not associated with the transportation platform. For example, the second user can have a user account with the transportation platform. In addition, or alternatively, the second user can include a passenger of the transportation service that is not associated with an account for the transportation platform (e.g., is not a user of the transportation platform).

As an example, in some implementations, the first user can request one or more seats for the transportation service. The request 305 can include at least one seat that is intended for at least one secondary user that is not the first user (e.g., a request for a transportation service including one seat for another user, a request for a transportation service including more than one seat—one for the first user and one for the secondary user, etc.). In such a case, the request 305 can include plus-one data 310 for the at least one secondary user (e.g., the second user) of the transportation service.

The plus-one data 310 can include data indicative of the second user. For example, plus-one data 310 can include communication data 320 for the second user such that the operations computing system 102 can communicate and/or interact with the second user (e.g., via the second user device 145). The communication data 320, for example, can include an identifier for the second user (e.g., a unique identifier indicative of a user account (e.g., an account number) on the transportation service platform, etc.). By way of example, the communication data 320 can be associated with a second user device 145 associated with the second user. The second user device 145 can include a software application associated with the transportation service platform running on the second user device 145 (e.g., a second user software application). In some implementations, this software application can be associated with a second user account of the transportation service platform. In such a case, the communication data 320 can include an account identifier associated with the second user account such that the operations computing system 102 can communicate with the second user through the software application running on the second user device.

In addition, or alternately, the communication data 320 can include contact data such as an email address and/or a phone number of the second user. The second user device 145 can be associated with this contact data. For example, the second user device 145 can be a mobile phone associated with the phone number of the second user and/or the second user device 145 can include an email application that utilizes the second user's email address. As such, the communication data 320 can include contact data such that the operations computing system 102 can communicate with the second user via the second user device 145 using the phone number (e.g., via text message, call, etc.), email address (e.g., via email message), etc.

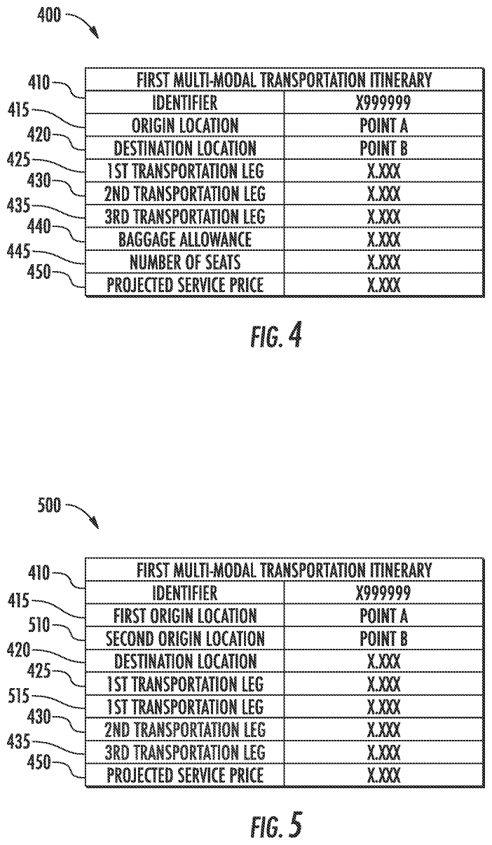

The plus-one data 310 can be received at any time before and/or during the transportation service. For example, as described in further detail below with reference to FIGS. 4-6, the operations computing system 102 can generate a multi-modal transportation itinerary for the first user and/or the second user of the transportation service. The multi-modal transportation itinerary can include one or more transportation legs. In some implementations, the plus-one data 310 can be received before the generation of the multi-modal transportation itinerary (e.g., during the service request such as, for example, before a booking of a vehicle for the first itinerary leg, before aerial vehicle seat reservation, assignment, etc.). In some implementations, the plus-one data 310 can be received during one or more legs of the multi-modal itinerary (e.g., during a first leg before arriving at the beginning of a second leg, etc.).

FIG. 4 depicts an example multi-modal transportation itinerary 400 according to example implementations of the present disclosure. A first multi-modal transportation itinerary 400 can be generated based on the request for the transportation service from the first user. The first multi-modal transportation itinerary 400 can include two or more transportation legs (e.g., a first transportation leg 425, a second transportation leg 430, a third transportation leg 435, etc.) between an origin location 415 and a destination location 420 specified in the request. The two or more transportation legs can include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities.

The first multi-modal itinerary 400 can include itinerary data indicative of one or more aspects of the first multi-modal itinerary 400. For instance, the first multi-modal itinerary 400 can include a unique identifier 410 corresponding to the itinerary. In addition, or alternatively, the first multi-modal itinerary 400 can include request characteristics such as a requested number of seats 445. Moreover, in some implementations, the first multi-modal itinerary 400 can include one or more transportation service limitations such as a baggage allowance 440. In some implementations, the first multi-modal itinerary 400 can include one or more predictions for the transportation service such as a projected service price 450, a projected time of arrival, etc.

The operations computing system 102 can obtain an itinerary for a second user (e.g., plus-one user) in a variety of manners. For instance, turning to FIG. 5, FIG. 5 depicts an example multi-modal transportation itinerary 500 with multiple first transportation legs according to example implementations of the present disclosure. For example, the operations computing system 102 can generate the first multi-modal transportation itinerary 500 for the first user and assign the first multi-modal transportation itinerary 500 to the first user of the transportation platform. Upon receiving the plus-one data, the operations computing system 102 can supplement the first multi-modal transportation itinerary 500 with the data indicative of the second user. By way of example, the operations computing system 102 can associate the second user with the first multi-modal transportation itinerary 500. In addition, or alternatively, the operations computing system 102 can assign the first multi-modal transportation itinerary 500 to the second user. In this manner, the first user and second user can be associated with the same multi-modal transportation itinerary (e.g., the first multi-modal transportation itinerary 500).

The first multi-modal transportation itinerary 500 can include multiple first, second, third, etc. legs for the transportation service. For example, the operations computing system can add an additional first leg 515 to the first multi-modal transportation itinerary 500 in response to receiving plus-one data including another origin location 510 different from the origin location 415 of the request for the transportation service. This can allow the operations computing system 102 to, for example, book a ground-based vehicle to pick-up the first user from a first origin 415 and another ground-based vehicle to pick-up the second user from a second origin 510, both travelling to the same aircraft facility for the users to board the same aerial vehicle for aerial transport. The same can done for any leg of the first multi-modal transportation itinerary based on the plus-one data.

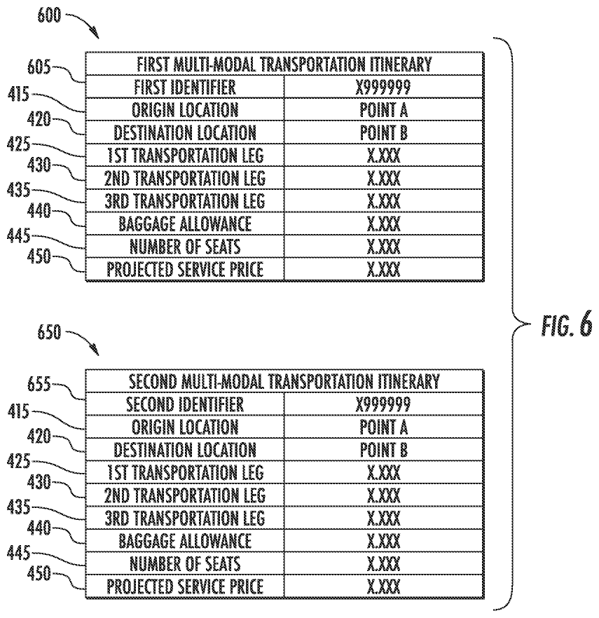

In some implementations, the operations computing system 102 can generate a second itinerary for the secondary user (e.g., to allow adjustment if permitted). For instance, FIG. 6 depicts a first multi-modal transportation itinerary 600 and a second multi-modal transportation itinerary 650 according to example implementations of the present disclosure. In some implementations, the operations computing system 102 can determine a second multi-modal transportation itinerary 650 for facilitating the aerial transport for the second user. For example, the second multi-modal transportation itinerary 650 can include a different multi-modal transportation itinerary than the itinerary 600 associated with the first user (e.g., with a different itinerary identifier 655, etc.). The second multi-modal transportation itinerary 650 can include the same and/or different information than the first multi-modal transportation itinerary 600. For example, the second multi-modal transportation itinerary 650 can at least initially match the first multi-modal transportation itinerary 600. By way of example, the operations computing system 102 can generate a second multi-modal transportation itinerary 650 for the second user that mirrors the first multi-modal transportation itinerary 600 associated with the first user and store the second multi-modal transportation itinerary 650 in an accessible database. This can enable, for example, a change to one itinerary without affecting the other itinerary.

In addition, or alternatively, the second multi-modal transportation itinerary 650 can include one or more different transportation legs than the first multi-modal transportation itinerary. For example, the plus-one data 310 can include a different origin and/or destination than the request for the transportation service. In such a case, a new multi-modal transportation itinerary can be generated for the second user based on the different origin and/or destination. In this manner, a second multi-modal transportation itinerary 650 can be generated that mirrors the first multi-modal transportation itinerary 600 associated with the first user in all respects but for a modified transportation leg and/or other features specific to the second user (e.g., seat assignments, luggage, payload, etc.).

Returning to FIG. 3, the operations computing system 102 can customize which itinerary information is available (e.g., accessible, viewable) to the first user and which itinerary information is available to the second user. For example, as described herein, the operations computing system 102 can generate itinerary data indicative of the first and/or second multi-modal transportation itinerary. The itinerary data, for example, can include a subset of information (e.g., identifier, destination location, type of travel, etc.) about the first and/or second multi-modal transportation itinerary that is available to the first user (e.g., via a first user device) and/or a subset of information about the first and/or second multi-modal transportation itinerary that is available to the second user (e.g., via a second user device). For instance, the operations computing system 102 can generate user itinerary data 360 that includes information accessible by the first user. For example, the operations computing system 102 can generate the user itinerary data 360 for the first user based one or more characteristics (e.g., as indicated by the first user's account, the request for the transportation service, etc.).

Additionally, or alternatively, the operations computing system 102 can generate passenger itinerary data 350 that includes information accessible by the second user. The operations computing system 102 can generate passenger itinerary data 350 for the second user based on the plus-one data 310 and/or the first and/or second multi-modal transportation itinerary(s). The passenger itinerary data 350 can be indicative of one or more portions of the first and/or second multi-modal transportation itinerary. By way of example, the passenger itinerary data 350 can include an itinerary identifier. The itinerary identifier can include, for example, an itinerary serial number, barcode, etc. unique to the respective itinerary. For instance, the itinerary identifier can be used to look up the itinerary (e.g., via a web browser, a first/second software application, etc.). In addition, or alternatively, the itinerary identifier can include a link to more information (e.g., reachable via a web browser, a first/second software application, etc.) about the respective itinerary. Moreover, in some implementations, the itinerary identifier can include information about the transportation platform. For example, in the event the second user does not have an account with the service entity's transportation platform, the passenger itinerary data 350 can include information on how to create an account, an option to join the transportation platform, a discount, etc. In this manner, the operations computing system 102 can enable the second user to view information pertaining to portions of the first and/or second multi-modal transportation itinerary(s).

The passenger itinerary data 350 can include data indicative of at least one of the transportation legs of the multi-modal transportation booked for the user(s). For example, the passenger itinerary data 350 can include an overview of the first and/or second multi-modal transportation itinerary. By way of example, the passenger itinerary data 350 can include an origin and destination location, mode of transportation, a start and arrival time, a seat assignment, etc. for each leg of the first and/or second multi-modal transportation itinerary. In addition, or alternatively, the passenger itinerary data 350 can include detailed information for at least one transportation leg. By way of example, the passenger itinerary data 350 can include a boarding pass for an aerial transportation leg of the at least two transportation legs. The boarding pass can include, for example, a seating assignment, terminal, flight number, security information, etc. for the aerial transportation leg of the first and/or second multi-modal transportation itinerary.

In some implementations, the passenger itinerary data 350 can include the same information as the user itinerary data 360. For example, the operations computing system 102 can be configured to communicate user itinerary data 360 to the first user device 140 associated with the first user. The user itinerary data 360 can include information for each of the transportation legs of the first and/or second multi-modal transportation itinerary. In some implementations, the passenger itinerary data 350 can mirror the user itinerary data 360 such that the first and second user have access (e.g., via the first and second user devices, respectively) to the same information for the first and/or second multi-modal transportation itinerary.

In addition, or alternatively, the passenger itinerary data 350 can be different than the user itinerary data 360. For example, as described above, the passenger itinerary data 350 can provide less information of the first and/or second multi-modal transportation itinerary than user itinerary data 360. For example, the passenger itinerary data 350 can include an abbreviated version of the multi-modal transportation itinerary information viewable by the first user (e.g., the information included in the user itinerary data 360). Additionally, in some implementations, the passenger itinerary data 350 can be indicative of second multi-modal transportation itinerary information, whereas the user itinerary data 360 can be indicative of at least a first multi-modal transportation itinerary information. For example, the user itinerary data 360 can include information about the first and second multi-modal transportation itinerary, whereas the passenger itinerary data 350 can be limited to information about the second multi-modal transportation itinerary. As another example, the user itinerary data 360 can be limited to information about the first multi-modal transportation itinerary and the passenger itinerary data 350 can be limited to the information about the second multi-modal transportation itinerary. In this manner, the operations computing system 102 can generate data indicative of a subset of information included in the first and/or second multi-modal transportation itinerary specific to the first and/or second user.

For example, the passenger itinerary data 350 can be indicative of first and/or second multi-modal transportation itinerary information relevant to the second user, whereas the user itinerary data 360 can be indicative of first and/or second multi-modal transportation itinerary information relevant to the first user. By way of example, the passenger itinerary data 350 can include an indication of the second user within a representation of the first and/or second multi-modal transportation itinerary (e.g., to illustrate the progress of the second user through the first and/or second multi-modal transportation itinerary), whereas the user itinerary data 360 can include an indication of the first user within a representation of the first and/or second multi-modal transportation itinerary (e.g., to illustrate the progress of the first user through the first and/or second multi-modal transportation itinerary).

In some implementations, the operations computing system 102 can modify the passenger itinerary data 350 before and/or during the transportation service. For example, the passenger itinerary data 350 can be modified based on a status (e.g., progress) of the second user through the first and/or second multi-modal transportation itinerary. For instance, the operations computing system 102 can identify a passenger status of the second user. The passenger status can include the second user's location relative to the first and/or second multi-modal transportation itinerary. The passenger status can include an indication of a current transportation leg within which the second user is travelling and the progress of the second user through the current transportation leg. By way of example, the passenger status can indicate that the second user has yet to begin, is currently travelling along, and/or has completed a transportation leg of the first and/or second multi-modal transportation itinerary.

The operations computing system 102 can modify the passenger itinerary data 350 to include relevant information (e.g., driver name, pilot name, type of vehicle, etc.) for a transportation leg of the first and/or second multi-modal transportation itinerary based on the second user's progress along the first and/or second multi-modal transportation itinerary (e.g., as indicated by the passenger status). In this manner, the passenger itinerary data 350 can be tailored to provide the second user with the most relevant data based on the second user's location within the first and/or second multi-modal transportation itinerary. For example, the operations computing system 102 can periodically communicate messages indicative of the trip progress to the second user device 145.

As briefly discussed above, the passenger itinerary data 350 indicative of the first and/or second multi-modal transportation itinerary can be communicated (e.g., by the operations computing system 102) to the second user device 145 associated with the second user. For example, the passenger itinerary data 350 can be communicated to the second user device 145 based on the plus-one data 310 (e.g., communication data 320 such as account number, phone number, etc.). The second user device 145, for example, can include any type of computing device such as a smartphone, tablet, hand-held computing device, wearable computing device, embedded computing device, navigational computing device, etc. The second user device 145 can include one or more communication interfaces (e.g., email client, second user software application, etc.) configured to communicate (e.g., via one or more networks such as local area networks, wide area networks, the Internet, secure networks, cellular networks, mesh networks, etc.) with the operations computing system 102.

In some implementations, the second user can update the first and/or second multi-modal transportation itinerary. For example, the operations computing system 102 can receive a user update request 330 for a change to the first and/or second multi-modal transportation itinerary from the second user device 145 associated with the second user. The user update request 330 can include at least one of supplemental itinerary data 335 and/or itinerary modification data 340.

The supplemental itinerary data 335, for example, can be indicative of supplemental information for the first and/or second multi-modal transportation itinerary. By way of example, the supplemental information can include passenger preferences (e.g., seating, climate, music, etc.), passenger characteristics (e.g., weight, height, disabilities, etc.), passenger security information (e.g., passport/license details, flight clearances such as CLEAR, TSA precheck, etc.), passenger flexibility (e.g., willingness to delay, rebook, etc. the transportation service), passenger feedback (e.g., driver reviews, pilot reviews, etc.), etc. The itinerary modification data 340, for example, can be indicative of a requested modification to the first and/or second multi-modal transportation itinerary. By way of the example, the itinerary modification data 340 can include ride modifications (ride cancellation, alternate pick-up/drop-off locations, etc.), ride confirmations (check-in, confirmation of pick-up, confirmation of drop-off, etc.), modification to seating arrangements, etc.

The operations computing system 102 can update the first and/or second multi-modal transportation itinerary based on the user update request 330. For example, the operations computing system 102 can update the first and/or second multi-modal transportation itinerary by supplementing the first and/or second multi-modal transportation itinerary with the supplemental itinerary data 335. By way of example, the operations computing system 102 can add second user details to the first and/or second multi-modal transportation itinerary based on the supplemental itinerary data 335. For instance, the operations computing system 102 can update the first and/or second multi-modal transportation itinerary by adding flight clearance details such as a TSA precheck clearance as specified by the second user (or an account associated with the second user) in the supplemental itinerary data 335. In this manner, the second user can update the first and/or second multi-modal transportation itinerary to include information specified by the second user.

In addition, or alternatively, the operations computing system 102 can update the first and/or second multi-modal transportation itinerary by modifying one or more transportation legs of the itinerary based on the itinerary modification data 340. By way of example, the itinerary modification data 340 can be indicative of a second user request to change an origin location for a first transportation leg of the first and/or second multi-modal transportation itinerary. In such a case, the operations computing system 102 can modify the first transportation leg to schedule a transportation service provider to pick up the second user at the new origin location (e.g., redirect a currently scheduled transportation service provider, schedule a new transportation service provider, etc.).

In some implementations, the first and/or second user's ability to update the first and/or second multi-modal transportation itinerary can be based, at least in part, on the first and/or second user's status (e.g., location) within the first and/or second multi-modal transportation itinerary. For instance, the availability to update a transportation leg of the first and/or second multi-modal transportation itinerary can depend on the progress of the first and/or second user through the first and/or second multi-modal transportation itinerary. By way of example, an update to a transportation leg of the multi-modal transportation itinerary can become unavailable once the first and/or second user has begun the transportation service assigned for that leg.

Moreover, in some implementations, the first user can update the first and/or second multi-modal transportation itinerary based at least in part on an interaction or desired interaction with the second user. For instance, the first user and/or second user can desire to split a price of the transportation service between the users and/or change a weight allocation between users (e.g., to accommodate the second user's heavier luggage, etc.). The operations computing system 102 can receive user interaction data 370 from the first user (e.g., via the first user device 140) and/or the second user (e.g., via the second user device 145). The user interaction data 370 can include an indication to split a price/reward associated with the first and/or second multi-modal transportation itinerary, an indication to allocate weight allowances (e.g., baggage allowance, etc.) associated with the first and/or second multi-modal transportation itinerary, etc. The operations computing system 102 can receive the interaction data 370 and update the first and/or second multi-modal transportation itinerary in accordance with the interaction data 370 by, for example, splitting a price associated with a transportation service associated with the first and/or second transportation itinerary, adjusting the payload allocation so that the second user is afforded a heavier payload allowance, etc.

In some implementations, the operations computing system 102 can determine whether to update the first and/or second multi-modal transportation itinerary in response to obtaining the user interaction data 370 and/or the user update request 330 based on the timing of the plus-one data 310. For instance, the operations computing system 102 can update different transportation legs of the first and/or second multi-modal transportation itinerary based on the user interaction data 370 and/or the user update request 330 based on the second user's status at the time the plus-one data 310 is received. By way of example, the operations computing system 102 can be configured to ignore requests to modify a transportation leg of first and/or second multi-modal transportation itinerary after the second user begins and/or finishes the transportation leg.

In addition, or alternatively, the operations computing system 102 can generate passenger itinerary data 350 and/or update the first and/or second multi-modal transportation itinerary based on a privilege level associated with the first and/or second user. For example, the second user can be associated with a privilege level indicative of a level of control over the first and/or second multi-modal transportation itinerary. By way of example, the privilege level can be one of a plurality of privilege levels. Each respective privilege level can be indicative of a respective level of control over a multi-modal transportation itinerary. Control over a multi-modal transportation itinerary can include, for example, an ability to view one or more details of the itinerary, an ability to supplement the itinerary, an ability to modify the itinerary, an ability to interact with another user associated with the itinerary, etc.

For instance, the second user's control over an itinerary can range from having no control (e.g., no ability to view details, provide information to, modify, etc.) to the same control over the itinerary as that of the first user. By way of example, the first user can have full control (e.g., to view, edit, supplement, etc.) over the itinerary generated in response to the first user's request. In some implementations, the second user can share the same control as the first user that requested the transportation service.

More particularly, a first privilege level can be indicative of a complete lack of control over an itinerary. A second user associated with this first privilege level can be associated with an itinerary but prohibited from viewing details of or modifying the itinerary. A second privilege level can be indicative of viewable control over an itinerary. For example, the second privilege level can indicate that the second user is an observer of the itinerary. For instance, the operations computing system 102 can provide up-to-date passenger itinerary data 350 to a second user device 145 associated with the second privilege level but ignore any user update request 330 or user interaction data 370 received from the second user device 145. A third privilege level can be indicative of an intermediate level of control over an itinerary. For example, the operations computing system 102 can provide up-to-date passenger itinerary data 350 to a second user device 145 associated with the third privilege level, supplement the itinerary based on supplemental itinerary data 335 received from the second user device 145, but ignore itinerary modification data 340 received from the second user device 145. As a fourth example, a fourth privilege level can be indicative of complete control over the itinerary. For instance, the operations computing system 102 can provide up-to-date passenger itinerary data 350 to a second user device 145 associated with the fourth privilege level, supplement the itinerary based on supplemental itinerary data 335 received from the second user device 145, and modify the itinerary based on itinerary modification data 340 received from the second user device 145. The fourth privilege level can be beneficial, for example, when a first user requests a transportation service for a second user that does not include a seat for the first user. In such a case, the second user can be assigned a fourth privilege level identifying the second user as the primary owner of the itinerary.

In some implementations, the first user can specify or request the privilege level associated with the second user. For instance, the plus-one data 310 can include priority data 325 indicative of the privilege level associated with the second user. The first user can provide priority data 325 to the operations computing system 102 with the plus-one data 310 (e.g., when generating a request for transportation). The priority data 325 can include a desired level of control for the second user over the itinerary as specified by the first user. In this manner, the priority data 325 can be dynamically set, via the first user device 140, by the first user. In addition, or alternatively, a second user can be assigned a default passenger privilege level (e.g., the first privilege level, second privilege level, etc.) that is assigned to all second users associated with a multi-modal transportation itinerary.

In some implementations, the operations computing system 102 can assign a privilege level to a second user based at least in part on the second user's relationship to the transportation platform. By way of example, a second user that is not associated with an account on the transportation platform can be assigned (e.g., by default) the first privilege level indicative of a complete lack of control over the first and/or second multi-modal transportation itinerary, whereas a second user associated with an account can be assigned (e.g., by default) a privilege level higher than the first privilege level. In addition, or alternatively, where the second user is associated with a user account, the operations computing system 102 can assign a privilege level to the second user based on characteristics (e.g., user rating, usage levels, age, etc.) of the second user's account. For instance, a second user associated with a user rating at or above a rating threshold can be assigned a higher privilege level (e.g., the fourth privilege level) than a second user associated with a user rating below the rating threshold (e.g., assigned the third privilege level). In this respect, a second user associated with a new account and/or an account with a low usage rate (e.g., as indicated by an age or history of use associated with the account) can be assigned a lower privilege level (e.g., a second privilege level) than a second user with an established account and/or a high usage rate (e.g., the third privilege level).

The operations computing system 102 can identify the privilege level associated with the second user (e.g., based on timing, the plus-one data 310, default priority, etc.) and generate the passenger itinerary data 350 based on the privilege level associated with the second user. For example, a privilege level can correspond to a level of detail of the first and/or second multi-modal transportation itinerary (e.g., the first privilege level can correspond to first level of detail, the second privilege level can correspond to a second, more in depth, level of detail, etc.). The operations computing system 102 can generate passenger itinerary data 350 based on the privilege level by reducing the level of detail for a lower privilege level and increasing the level of detail for a higher privilege level. For instance, the operations computing system 102 can generate passenger itinerary data 350 indicative of an overview of the first and/or second multi-modal transportation itinerary for a lower privilege level (e.g., a second privilege level) and passenger itinerary data 350 indicative of a detailed overview of each transportation leg of the first and/or second multi-modal transportation itinerary for a higher privilege level (e.g., a fourth privilege level). The operations computing system 102 can communicate the passenger itinerary data 350 to the second user device 145 based on the privilege level associated with the second user. In this manner, the operations computing system 102 can control the second user's ability to view details of the first and/or second multi-modal transportation itinerary based on a privilege level associated with the second user.

In some implementations, the operations computing system 102 can identify the privilege level associated with the second user (e.g., based on timing, the plus-one data 310, default priority, etc.) and determine whether to update the first and/or second multi-modal transportation itinerary based on the privilege level associated with the second user. For example, the operations computing system 102 can determine whether the privilege level is above a threshold privilege level before updating the first and/or second multi-modal transportation itinerary in response to a user update request 330 from the second user. For instance, the supplemental itinerary data 335 can be associated with a first threshold privilege level (e.g., the third privilege level). In addition, or alternatively, the itinerary modification data 340 can be associated with a second threshold privilege level (e.g., the fourth privilege level). In some implementations, the first threshold privilege level can be lower than the second threshold privilege level.

The operations computing system 102 can determine whether the privilege level is above the first threshold privilege level or the second threshold privilege level and can update the first and/or second multi-modal itinerary based on the determination of whether the privilege level is above the first threshold privilege level and/or the second threshold privilege level. For example, the operations computing system 102 can update the first and/or second multi-modal transportation itinerary in the event that the user update request 330 includes supplemental itinerary data 335 and the second user is associated with a privilege level at or above the first threshold privilege. As another example, the operations computing system 102 can ignore a user update request 330 in the event that the user update request 330 comprises supplemental itinerary data 335 and the second user is associated with a privilege level below the first threshold privilege level. In this manner, the operations computing system 102 can limit the control of the second user over the first and/or second multi-modal transportation itinerary based on a privilege level associated with the second user.

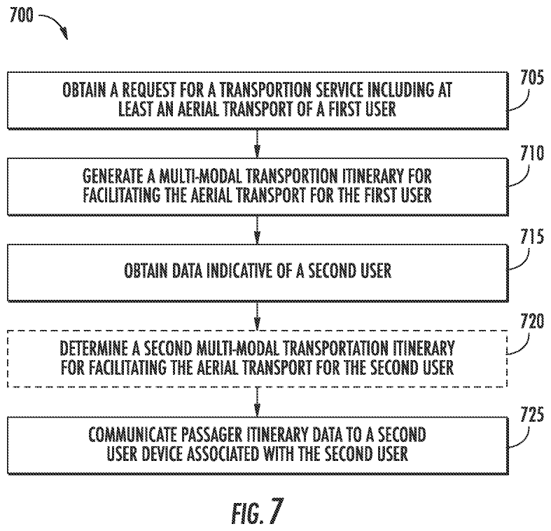

FIG. 7 depicts a flowchart diagram of an example method of communicating with secondary users of the transportation service according to example implementations of the present disclosure. One or more portion(s) of the method 700 can be implemented by a computing system that includes one or more computing devices such as, for example, the computing systems described with reference to the other figures (e.g., the operations computing system 102, the first user computing device 140, the second user computing device 145, service provider computing device for transportation modalities 150, 160, 170, infrastructure and operations computing devices 190, vehicle provider computing devices 195, etc.). Each respective portion of the method 700 can be performed by any (or any combination) of one or more computing devices. Moreover, one or more portion(s) of the method 700 can be implemented as an algorithm on the hardware components of the device(s) described herein (e.g., as in FIGS. 1, 10-11, etc.), for example facilitate communications between secondary users of the transportation service. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At 705, the method includes obtaining a request for a transportation service including at least an aerial transport of a first user. For example, a computing system (e.g., operations computing system 102, etc.) can obtain a request for a transportation service that includes at least an aerial transport of a first user. The request can be generated via a first user device associated with the first user. The first user device, for example, can include a software application for a transportation platform configured to fulfill and plan a multi-modal service running on the first user device.

At 710, the method includes generating a multi-modal transportation itinerary for facilitating the aerial transport for the first user. For example, a computing system (e.g., operations computing system 102, etc.) can generate a first multi-modal transportation itinerary for facilitating the aerial transport for the first user. The itinerary can include at least a first transportation leg, a second transportation leg, and a third transportation leg.

At 715, the method includes obtaining data indicative of a second user. For example, a computing system (e.g., operations computing system 102, etc.) can obtain data indicative of a second user that is to travel with the first user for at least a portion of the first multi-modal transportation itinerary. In some implementations, the data indicative of the second user can include a privilege level associated with the second user.

At 720, the method includes determining a second multi-modal transportation itinerary for facilitating the aerial transport for the second user. For example, a computing system (e.g., operations computing system 102, etc.) can determine a second multi-modal transportation itinerary for facilitating the aerial transport for the second user. The second multi-modal transportation itinerary can at least initially match the first multi-modal transportation itinerary.

In addition, or alternatively, the method can include associating the second user with the first multi-modal transportation itinerary. For example, the second user can be a passenger of the first multi-modal transportation service that is to travel with the first user for at least a portion of the multi-modal transportation. In this manner, the first user and the second user can be associated the same multi-modal transportation itinerary.

At 725, the method includes communicating passenger itinerary data to a second user device associated with the second user. For example, a computing system (e.g., operations computing system 102, etc.) can communicate passenger itinerary data indicative of the second multi-modal transportation itinerary to a second user device associated with the second user. In addition, or alternatively, the method can include communicating passenger itinerary data indicative of the first multi-modal transportation itinerary to the second user device. In some implementations, the second user can be associated with a second user device that does not include a software application for the transportation platform.

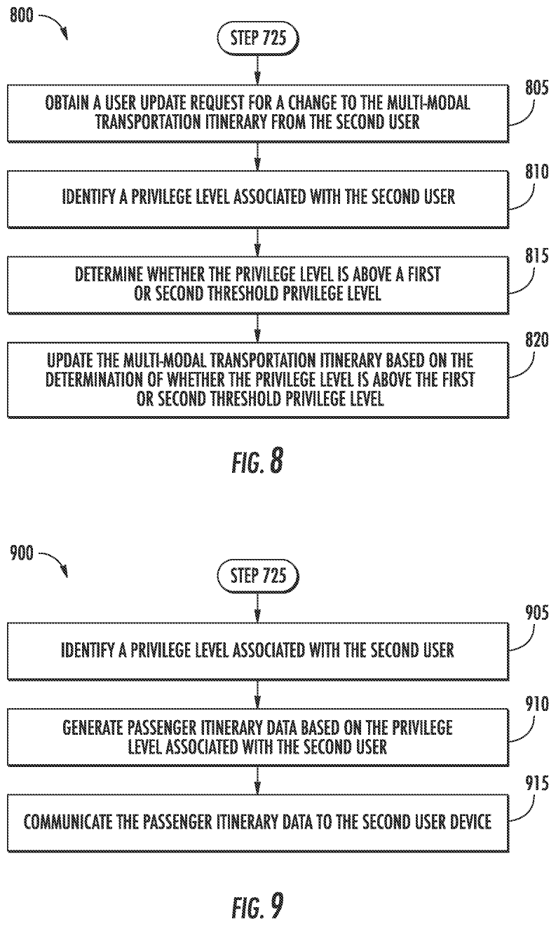

FIG. 8 depicts a flowchart diagram of an example method of communicating with secondary users of the transportation service according to example implementations of the present disclosure. One or more portion(s) of the method 800 can be implemented by a computing system that includes one or more computing devices such as, for example, the computing systems described with reference to the other figures (e.g., the operations computing system 102, the first user computing device 140, the second user computing device 145, service provider computing device for transportation modalities 150, 160, 170, infrastructure and operations computing devices 190, vehicle provider computing device, 195, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1, 10-11, etc.), for example facilitate communications between secondary users of the transportation service. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

Method 800 begins at step 725 where the method 700 includes communicating passenger itinerary data to a second user device associated with the second user.

At 805, the method includes obtaining a user update request for a change to the multi-modal transportation itinerary from the second user. For example, a computing system (e.g., operations computing system 102, etc.) can obtain, via a second user device, a user update request for a change to the first and/or second multi-modal transportation itinerary for the second user.

At 810, the method includes identifying a privilege level associated with the second user. For example, a computing system (e.g., operations computing system 102, etc.) can identify the privilege level associated with the second user. For instance, the second user can be associated with a privilege level indicative of a level of control over the first and/or second multi-modal transportation itinerary. For example, in some implementations, the data indicative of the second user can include priority data indicative of the privilege level associated with the second user. The priority data can be set, for example, via the first user device, by the first user.

At 815, the method includes determining whether the privilege level is above a first or second threshold privilege level. For example, a computing system (e.g., operations computing system 102, etc.) can determine whether the privilege level is above a first threshold privilege level or a second threshold privilege level. For instance, a user update request can include at least one of supplemental itinerary data and itinerary modification data. The supplemental itinerary data can be indicative of at least one of passenger preferences, passenger characteristics, passenger security information, passenger flexibility, and/or passenger feedback. The itinerary modification data can be indicative of a new destination location, origin location, timing, etc. for the second multi-modal transportation itinerary. In some implementations, the supplemental itinerary data can be associated with a first threshold privilege level, and the itinerary modification data can be associated with a second threshold privilege level.

At 820, the method includes updating the first and/or second multi-modal transportation itinerary based on the determination of whether the privilege level is above the first or second threshold privilege level. For example, a computing system (e.g., operations computing system 102, etc.) can update the first and/or second multi-modal transportation itinerary based, at least in part, on the user update request. For instance, the computing system can update the first and/or second multi-modal transportation itinerary based, at least in part, on the determination of whether the privilege level associated with the user request is above the first threshold privilege level or the second threshold privilege level.

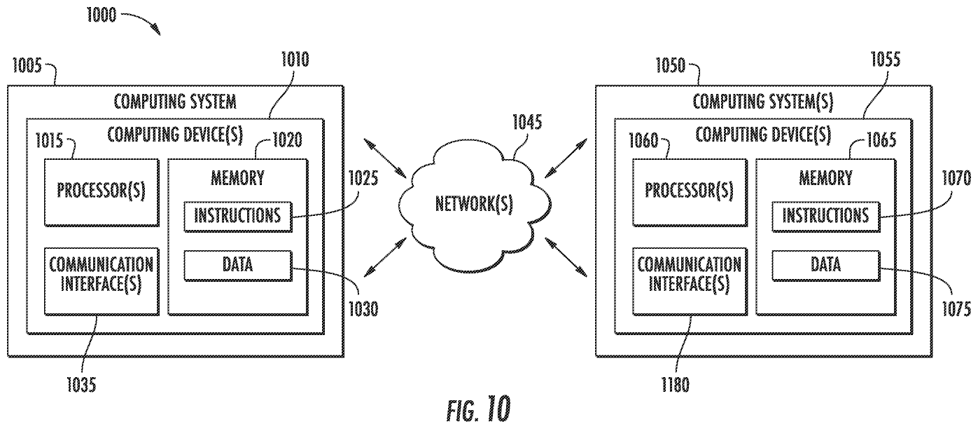

FIG. 9 depicts a flowchart diagram of an example method of communicating with secondary users of the transportation service according to example implementations of the present disclosure. One or more portion(s) of the method 900 can be implemented by a computing system that includes one or more computing devices such as, for example, the computing systems described with reference to the other figures (e.g., the operations computing system 102, the first user computing device 140, the second user computing device 145, service provider computing device for transportation modalities 150, 160, 170, infrastructure and operations computing devices 190, vehicle provider computing devices 195, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1, 10-11, etc.), for example facilitate communications between secondary users of the transportation service. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for exemplary illustrated purposes and is not meant to be limiting. One or more portions of method 900 can be performed additionally, or alternatively, by other systems.

Method 900 begins at step 725 where the method 700 includes communicating passenger itinerary data to a second user device associated with the second user.

At 905, the method includes identifying a privilege level associated with the second user. For example, a computing system (e.g., operations computing system 102, etc.) can identify the privilege level associated with the second user. For instance, the second user can be associated with a privilege level indicative of a level of control over the first and/or second multi-modal transportation itinerary. For example, in some implementations, the data indicative of the second user can include priority data indicative of the privilege level associated with the second user. The priority data can be set, for example, via the first user device, by the first user.

At 910, the method includes generating passenger itinerary data based on the privilege level associated with the second user. For example, a computing system (e.g., operations computing system 102, etc.) can generate the passenger itinerary data based, at least in part, on the privilege level associated with the second user. For instance, the passenger itinerary data can include an indication of the second user within a representation of the first and/or second multi-modal transportation itinerary.

At 915, the method includes communicating the passenger itinerary data to the second user device. For example, a computing system (e.g., operations computing system 102, etc.) can communicate passenger itinerary data indicative of the first and/or second multi-modal transportation itinerary to a second user device associated with the second user based, at least in part, on the privilege level associated with the second user.

In addition, or alternatively, the method can include communicating user itinerary data to the first user device associated with the first user. In some implementations, the passenger itinerary data can provide less information of the multi-modal transportation itinerary than the user itinerary data.

FIG. 10 depicts example system components of an example system 1000 according to example embodiments of the present disclosure. The example system 1000 can include the computing system 1005 (e.g., an operations computing system 102) and the computing system(s) 1150 (e.g., first user computing devices 140, second user computing devices 145, service provider computing device(s) 150, 160, 170, infrastructure computing devices 190, etc.), etc. that are communicatively coupled over one or more network(s) 1045.

The computing system 1005 can include one or more computing device(s) 1010. The computing device(s) 1010 of the computing system 1005 can include processor(s) 1015 and a memory 1020. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 can store information that can be accessed by the one or more processors 1015. For instance, the memory 1020 (e.g., one or more non-transitory computer-readable storage mediums, memory devices) can include computer-readable instructions 1025 that can be executed by the one or more processors 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processors 1015 cause the one or more processors 1015 to perform operations such as any of the operations and functions of the operations computing system 102, or for which the operations computing system 102 is configured, as described herein.

The memory 1020 can store data 1030 that can be obtained, received, accessed, written, manipulated, created, and/or stored. The data 1030 can include, for instance, itinerary data, user data, passenger data, transportation request data, plus-one data, communication data, priority data, and/or other data/information described herein. In some implementations, the computing device(s) 1010 can obtain from and/or store data in one or more memory device(s) that are remote from the computing system 1005 such as one or more memory devices of the computing system 1050.

The computing device(s) 1010 can also include a communication interface 1035 used to communicate with one or more other system(s) (e.g., computing system 1050). The communication interface 1035 can include any circuits, components, software, etc. for communicating via one or more networks (e.g., 1045). In some implementations, the communication interface 1035 can include for example, one or more of a communications controller, receiver, transceiver, transmitter, port, conductors, software and/or hardware for communicating data/information.

The computing system 1050 can include one or more computing devices 1055. The one or more computing devices 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more non-transitory computer-readable storage media, such as RAM, ROM, EEPROM, EPROM, one or more memory devices, flash memory devices, etc., and combinations thereof.

The memory 1065 can store information that can be accessed by the one or more processors 1060. For instance, the memory 1065 (e.g., one or more non-transitory computer-readable storage mediums, memory devices) can store data 1075 that can be obtained, received, accessed, written, manipulated, created, and/or stored. The data 1075 can include, for instance, user itinerary data, passenger itinerary data, and/or other data or information described herein. In some implementations, the computing system 1050 can obtain data from one or more memory device(s) that are remote from the computing system 1050.

The memory 1065 can also store computer-readable instructions 1070 that can be executed by the one or more processors 1060. The instructions 1070 can be software written in any suitable programming language or can be implemented in hardware. Additionally, or alternatively, the instructions 1070 can be executed in logically and/or virtually separate threads on processor(s) 1060. For example, the memory 1065 can store instructions 1070 that when executed by the one or more processors 1060 cause the one or more processors 1060 to perform any of the operations and/or functions described herein, including, for example, any of the operations and functions of the first user computing devices 140, second user computing devices 145, service provider computing device(s) 150, 160, 170, infrastructure computing devices 190, and/or other operations and functions.

The computing device(s) 1055 can also include a communication interface 1080 used to communicate with one or more other system(s). The communication interface 1080 can include any circuits, components, software, etc. for communicating via one or more networks (e.g., 1045). In some implementations, the communication interface 1080 can include for example, one or more of a communications controller, receiver, transceiver, transmitter, port, conductors, software and/or hardware for communicating data/information.

The network(s) 1045 can be any type of network or combination of networks that allows for communication between devices. In some embodiments, the network(s) 1045 can include one or more of a local area network, wide area network, the Internet, secure network, cellular network, mesh network, peer-to-peer communication link and/or some combination thereof and can include any number of wired or wireless links. Communication over the network(s) 1045 can be accomplished, for instance, via a network interface using any type of protocol, protection scheme, encoding, format, packaging, etc.

FIG. 10 illustrates one example system 1000 that can be used to implement the present disclosure. Other computing systems can be used as well. Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system comprising:
one or more processors; and
one or more non-transitory computer-readable media that collectively store instructions that, when executed by the one or more processors, cause the computing system to perform operations, the operations comprising:
obtaining a request for a transportation service that comprises at least an aerial transport of a first user, wherein the request is generated via a first user device associated with the first user;
generating a first multi-modal transportation itinerary for facilitating the aerial transport for the first user, the itinerary comprising at least a first transportation leg, a second transportation leg, and a third transportation leg;
obtaining data indicative of a second user that is to travel with the first user for at least a portion of the first multi-modal transportation itinerary;
determining a second multi-modal transportation itinerary for facilitating the aerial transport for the second user, wherein the second multi-modal transportation itinerary at least initially matches the first multi-modal transportation itinerary; and
communicating passenger itinerary data indicative of the second multi-modal transportation itinerary to a second user device associated with the second user.

2. The computing system of claim 1, further comprising:
obtaining, by the computing system via the second user device, a user update request for a change to the second multi-modal transportation itinerary for the second user; and
updating, by the computing system, the second multi-modal transportation itinerary based, at least in part, on the user update request.

3. The computing system of claim 2, wherein the second user is associated with a privilege level indicative of a level of control over the second multi-modal transportation itinerary.

4. The computing system of claim 3, wherein the data indicative of the second user comprises priority data indicative of the privilege level associated with the second user.

5. The computing system of claim 4, wherein the priority data is set, via the first user device, by the first user.

6. The computing system of claim 3, wherein the user update request comprises at least one of supplemental itinerary data and itinerary modification data.

7. The computing system of claim 6, wherein the supplemental itinerary data is indicative of at least one of passenger preferences, passenger characteristics, passenger security information, passenger flexibility, or passenger feedback.

8. The computing system of claim 6, wherein the itinerary modification data is indicative of a new destination location for the second multi-modal transportation itinerary.

9. The computing system of claim 6, wherein the supplemental itinerary data is associated with a first threshold privilege level, and the itinerary modification data is associated with a second threshold privilege level.

10. The computing system of claim 9, wherein updating the second multi-modal transportation itinerary further comprises:
identifying, by the computing system, the privilege level associated with the second user;
determining, by the computing system, whether the privilege level is above the first threshold privilege level or the second threshold privilege level; and
updating, by the computing system, the second multi-modal transportation itinerary based, at least in part, on the determination of whether the privilege level is above the first threshold privilege level or the second threshold privilege level.

11. A computer-implemented method comprising:
obtaining, by a computing system comprising one or more computing devices, a request for a transportation service that comprises at least an aerial transport of a first user, wherein the request is generated via a first user device associated with the first user;
generating, by the computing system, a multi-modal transportation itinerary for facilitating the aerial transport for the first user, the itinerary comprising at least a first transportation leg, a second transportation leg, and a third transportation leg;
obtaining, by the computing system from the first user device, data indicative of a second user associated with the first user, wherein the data indicative of the second user comprises a privilege level associated with the second user;
associating, by the computing system, the second user with the multi-modal transportation itinerary; and
communicating, by the computing system, passenger itinerary data indicative of the multi-modal transportation itinerary to a second user device associated with the second user based, at least in part, on the privilege level associated with the second user.

12. The computer-implemented method of claim 11, further comprising:
obtaining, by the computing system via the second user device, a user update request for a change to the multi-modal transportation itinerary; and
updating, by the computing system, the multi-modal transportation itinerary based, at least in part, on the user update request.

13. The computer-implemented method of claim 12, wherein the second user is a passenger of the multi-modal transportation service that is to travel with the first user for at least a portion of the multi-modal transportation, and
wherein the first user and the second user are associated the same multi-modal transportation itinerary.

14. The computer-implemented method of claim 12, wherein updating the multi-modal transportation itinerary further comprises:
identifying, by the computing system, the privilege level associated with the second user; and
updating, by the computing system, the multi-modal transportation itinerary based, at least in part, on the privilege level associated with the second user.

15. The computer-implemented method of claim 11, wherein communicating passenger itinerary data indicative of the multi-modal transportation itinerary to a second user device associated with the second user based, at least in part, on the privilege level associated with the second user comprises:
identifying, by the computing system, the privilege level associated with the second user;
generating, by the computing system, the passenger itinerary data based, at least in part, on the privilege level associated with the second user; and
communicating, by the computing system, the passenger itinerary data to the second user device.

16. The computer-implemented method of claim 15, further comprising:
communicating, by the computing system, user itinerary data to the first user device associated with the first user.

17. The computer-implemented method of claim 16, wherein the passenger itinerary data provides less information of the multi-modal transportation itinerary than the user itinerary data.

18. The computer-implemented method of claim 11, wherein the passenger itinerary data comprises an indication of the second user within a representation of the multi-modal transportation itinerary.

19. A computing system comprising:
one or more processors; and
one or more non-transitory computer-readable media that collectively store instructions that, when executed by the one or more processors, cause the computing system to perform operation, the operations comprising:
obtaining a request for a transportation service that comprises at least an aerial transport of a first user, wherein the request is generated via a first user device associated with the first user;
generating a multi-modal transportation itinerary for facilitating the aerial transport for the first user, the itinerary comprising at least a first transportation leg, a second transportation leg, and a third transportation leg;
obtaining, from the first user device, data indicative of a second user associated with the first user;
associating the second user with the multi-modal transportation itinerary; and
communicating passenger itinerary data indicative of the first transportation leg, the second transportation leg, and the third transportation leg to a second user device associated with the second user.

20. The computing system of claim 19, wherein the first user is associated with a first user device comprising a software application for a transportation platform configured to fulfill and plan a multi-modal service running on the first user device; and
the second user is associated with a second user device that does not comprise a software application for the transportation platform.
